(19) United States
(12) Patent Application Publication
(10) Pub. No.: US 2006/0000556 A1
(43) Pub. Date: Jan. 5, 2006

(54) Device for removing recording material from recording medium

(75) Inventor: Isao Mochizuki, Kaizu-gun (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/158,333

(22) Filed: Jun. 22, 2005

(30) Foreign Application Priority Data
Jun. 23, 2004 (JP) 2004-185087
Jun. 23, 2004 (JP) 2004-185094
Jun. 23, 2004 (JP) 2004-185119

(51) Int. Cl. B29C 65/00

(52) U.S. Cl. 156/584

(57) ABSTRACT

A regenerating device for a recording medium is provided. It is able to prevent the generation of waves and damages on the recording material, thereby stably keeping the quality of the recording medium, even where the recording medium having a separation layer thereon is repeatedly recycled. Hence, the recording medium is bonded to a first separating member by a melted or softened recording material when the recording medium is brought into contact with the heated first separating member. And the recording medium is nipped by a nipping-feeding part until the recording medium is separated from the first separating member and the recording material is cooled and solidified. Then, the recording medium is separated from the first separating member.

### BACKGROUND OF THE INVENTION

1. Field of the Invention

The present invention relates to a recording material removing device for removing a recording material that has been transferred and recorded onto a recording medium, and remained on the recording medium. More particularly, the present invention relates to a recording material removing device for enabling reuse of a recording medium by removing a recording material having been used once for recording of characters, images, or the like and remained on the recording medium, and a cleaning technique of a separating member used in the recording material removing device.

2. Description of Related Art

Even though recent developments in electronic technology have heralded the arrival of a paperless era, the amount of consumption of recording medium such as copy paper or the like continues increasing in association with the increasing number of production of output devices such as a copying machine, a laser beam printer, and an ink jet printer.

Under such circumstances, the recycling of used paper has been brisk recently. Used paper sorted in offices has been recycled by way of used paper collectors and paper factories. However, the problems may occur that recycling takes a long time and causes an increase in cost and a deterioration in the quality of paper. Hence, attention has been given to a technique for reusing recording paper having been used for recording of characters, images, or the like.

Heretofore, there have been known various types of means for a removing recording material having been formed on a recording medium in an image forming apparatus such as a copying machine. For instance, as the means using solvents, Japanese patent application laid-open No. H1(1989)-101576 discloses a recording material removing method in which paper onto which a recording material, or toner, has adhered is dipped into a soluble solvent of toner resin and a supersonic wave is vibrated to separate the toner dissolved in the solvent from the paper surface. Japanese patent application laid-open No. H4(1992)-300395 discloses a recording material removing method in which a solvent is attached to a printed portion of used paper by dipping, spraying or coating to dissolve toner so that the dissolved toner is removed by a method such as cleaning, air suction, adsorbent contact, mechanical separation, or electrostatic adsorption.

However, the method that the recording material is dipped into a recording material erasing accelerating agent, such as the solvent, needs provision of a means for supply and discharge of the solvent or regular replacement thereof. Maintenance of the accelerating agent would be sometimes difficult. Further, an additional step has to be provided to dry the recording medium having been dipped once in the recording material clearing accelerating agent. This may cause disadvantages in cost and space.

Using the solvent, which is consumable, this method may cause a high recycling cost. There is also concern about inflammability and toxicity resulting from the solvent. It is further necessary to provide a step of drying and removing the solvent saturated in the paper after removal of the recording material. This may cause an increase in size of the device and a need of heating energy for drying. Consequently, there is concern about air pollution by exhaust gas. When the paper processed once with the solvent is dried, furthermore, the quality of recycled paper may be deteriorated; for example, the paper becomes wavy and the fiber of a surface thereof fuzzes.

Furthermore, as a means using no solvent, for example, Japanese patent applications laid-open Nos. H4(1992)-082983 and H7(1995)-199757 disclose a recording material removing device including two rollers arranged in parallel and rotatable in close contact with each other to allow paper to pass through a contact portion, a heater for heating at least one of the rollers, a scrapping tool for separating the paper having passed through the contact portion from the roller, and a cleaning device for removing a recording material adhering to the roller from the roller.

This device is excellent in nonuse of extra consumable supplies and dangerous materials, and no damage to the recording medium which may be caused by mechanical direct separating to the recording medium.

This recording material removing device, however, would cause a problem that when the paper having passed through the contact portion is scraped by the scraping tool separated from the roller, the recording material having not solidified causes cobwebbing between the roller and the paper and remains on the paper.

This recording material removing device uses, as the cleaning device for removing the recording material adhering to the roller, a metallic or heat-resistant resinous blade, a brush, or a third roller provided in contact with the two parallel rollers to remove the recording material adhering to the third roller. However, the following problems are conceivable. When the blade leaves the recording material unremoved if once, the remaining material is transferred again to the paper. If the brush is soft, it could not remove the recording material. If the brush is firm, it would scratch the roller, so that the recording material remains in a scratched portion and may be transferred again onto the paper. The third roller would cause instability of transfer.

To solve the above problems, Japanese patent application laid-open No. H8(1996)-335012 discloses a recording material removing device which brings a belt-shaped separating member into contact with a recording material adhering to a recording medium to make the recording material adhere to the separating member. In this device, as a cleaning device for removing and cleaning the recording material adhering onto the belt-shaped separating member, a roller-shaped cleaning member having a spiral edge at the outer periphery which contacts with the surface of the separating member, driving means for driving the cleaning member to rotate, and a backup member having a surface portion formed of an elastic body which is brought into contact with the cleaning member through the separating member.

This device, which uses no extra consumable supplies and dangerous materials, is also excellent in that it would not cause damage to the recording medium which may caused by the mechanical direct separating to the recording medium.

Since the roller-shaped clearing member having the spiral edge at the outer periphery is a rigid body, however, it is difficult to adjust a clearance between the entire roller and the backup member having the surface portion formed of the elastic body. Adjustment error of the clearance would lead to a problem that the recording medium or the separating member may be shaved and a problem that the recording material may be left unremoved. Furthermore, the removed recording material does not flow out of the roller and stops between the spiral edges held in contact with the surface of the separating member, which is likely to interfere with an operation of removing the recording material from a surface of another separating member.

On the other hand, Japanese patent application laid-open No. H7(1995)-199757 has proposed a method of removing a recording material by pressing a blade against the recording material to scrape it off.

The method of removing the recording material by pressing the blade against the recording material to scrape it off needs no heat and no accelerating agent for clearing of a recording material and therefore is advantage in cost, space, and maintenance.

It is however supposed that the method for scraping the recording material off by merely pressing the blade against recording paper may cause a problem that the rigid blade, which is always in contact with the recording paper, scratches the surface of the recording paper. Since the blade is merely pressed against the recording paper to scrape the recording material off, the blade is more strongly pressed against the recording paper if the recording material could not be scraped off, leading to more deeply scratch the surface of the recording paper, which falls in a vicious cycle.

It is also supposed that the method of scraping the recording material off by pressing the blade against the recording paper may leave the recording material unremoved on edge portions of the recording paper depending on timings of conveying the recording paper and pressing the blade against the recording paper.

### SUMMARY OF THE INVENTION

The present invention has been made to solve the above problems and has an object to provide a reproducing device for a recording medium having thereon a separation layer, which can suppress the generation of waves and scratches in the recording medium and stably keep the quality of the recording medium even when the recording medium is repeatedly recycled.

More concretely, a first object is to provide a recording material removing device which brings a belt-shaped separating member into contact with a recording material adhering to a recording medium, thereby making the recording material adhere to the separating member, the recording material removing device having a simple structure capable of completely transferring the recording material onto the separating to prevent the recording material from remaining on the recording medium, thereby stably keeping the quality of the recording medium.

A second object is to provide a recording material removing device which brings a belt-shaped separating member into contact with a recording material adhering to a recording medium, thereby making the recording material adhere to the separating member, the recording material removing device having a simple structure capable of removing the recording material from the separating member to prevent a remaining recording material from flowing to a post-process, thereby preventing retransfer of the recording material to the recording medium and stably keeping the quality of the recording medium.

A third object is to provide a method of removing a recording material from a surface of recording paper by using a mechanical force, the method being able to minimize the mechanical force with as a simple structure as possible to remedy the cost and space problems and ensure a reduction in production cost of a removing means and regular replacement thereof, prevent damages such as scratches and streaks on the recording paper, and prevent the recording material from becoming unremoved on an edge or a part of the recording paper.

To achieve the purpose, according to a first aspect of the present invention, there is provided a recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated and removed from the recording medium, wherein the recording material removing device is constructed to bond the recording medium to the separating member by the recording material melted or softened when the recording medium is brought into contact with the heated belt-shaped separating member, and separate the recording medium from the separating member when the recording material is cooled and solidified while the separating member and the recording medium are nipped by the nipping member.

In the above recording material removing device for the recording medium, the recording medium is bonded to the separating member with the recording material melted or softened when the recording medium is brought into contact with the heated belt-shaped separating member, and the recording material is nipped by the nipping member until the recording medium is separated from the separating member. Accordingly, it has an effect of solving the problem that the recording medium comes off from the separating member due to warping or the like of the recording medium before the recording material is cooled and solidified, and the unsolidified recording material causes cobwebbing between the separating member and the recording medium and remains on the recording medium.

According to another aspect of the present invention, there is provided a recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated and removed from the recording medium, wherein the recording material removing device comprises a first separating member and a second separating member and is constructed to nip and convey the recording medium by the heated first separating member and the second separating member, and separate the recording medium from the first separating member and the second separating member when the recording material bonding the recording medium and the first separating member and the second separating member is cooled and solidified.

Since the above recording material removing device includes the first and second separating members to nip and convey the recording medium, it has an effect of solving the problem that the recording medium comes off from the first or second separating member and the unsolidified recording material causes cobwebbing between the first separating member and the recording medium or between the second separating member and the recording medium, and thus remains on the recording medium.

Further, the recording medium is separated from the first and second separating members when the recording material is cooled and solidified. Accordingly, there is an effect of solving a problem that the unsolidified recording material causes cobwebbing between the separating member and the recording medium and remains on the recording medium. Since the recording material can be removed simultaneously from both surfaces of the recording medium on which the recording material has thermally been fixed, there is an effect of producing the device for removing the recording material from both surfaces at low cost. Further, there is an effect of charging even the recording medium having one surface on which the recording material has thermally been fixed into the recording material removing device for the recording medium regardless of either surface, front or back.

According to another aspect of the present invention, there is provided a recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated from the recording medium and removed, wherein the recording material removing device comprises a recording material removing blade for removing the recording material by coming in contact with a surface of the separating member and a supporting member in a position opposite to the recording material removing blade with the separating member being interposed therebetween, and the recording material removing blade is configured to reciprocate with respect to the separating member while pressing against the supporting member through the separating member.

The above recording material removing device for the recording medium includes the recording material removing blade in contact with the surface of the separating member and removes the recording material and the supporting member placed opposite to the recording material removing blade through the separating member. The recording material removing blade is arranged to reciprocate with respect to the separating member while pressing against the supporting member through the separating member. Thus, the areas where the recording material removing blade removes the recording material from the separating member are overlapped, ensuring removal of the recording material from the separating member. There is an effect of eliminating the problem that the recording material could not be removed from the area where the blade has failed removing once.

According to another aspect of the present invention, there is provided a recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated from the recording medium and removed, wherein the recording material removing device comprises a recording material removing blade for removing the recording material by coming in contact with a surface of the separating member, a supporting member in a position opposite to the recording material removing blade with the separating member being interposed therebetween, and a cleaning member for simultaneously cleaning the recording material removing blade and the separating member while the recording material removing blade removes the recording material from the separating member by pressing against the supporting member through the separating member.

The above recording material removing device includes the recording material removing blade in contact with the surface of the separating member and removes the recording material, the supporting member placed opposite to the recording material removing blade through the separating member, and the cleaning member for simultaneously cleaning the recording material removing blade and the separating member while the recording material removing blade removes the recording material from the separating member by pressing against the supporting member through the separating member. Accordingly, the cleaning member will clean the recording material removing blade just after removal of the recording material by the recording material removing blade. This provide an effect of resolving the problem that the recording material adheres to the blade, deteriorating a recording material removing capacity.

Even when the recording material disperses forward of the recording material removing blade while the recording material removing blade is removing the recording material from the separating member, the cleaning member will clean the recording material removing blade and the separating member just after dispersion. Accordingly, there is an effect of solving the problem that the recording material would be caught between the separating member and the recording material removing blade and remain unremoved.

According to another aspect of the present invention, there is provided a recording material removing device for removing a recording material on a recording medium by pressing a blade against a separation layer on the recording medium on which the recording material has thermally been fixed, wherein the recording material removing device comprises a squeezing member provided with an arc-shaped end at a distal end, a control member for controlling so that a surface of the recording medium having no separation layer comes in contact with the arc-shaped end of the squeezing member, a blade for removing the recording material thermally fixed on the separation layer on the recording medium in a control region to be controlled by the control member.

The above recording material removing device includes the squeezing member provided with the arc-shaped end at the distal end, the control member for controlling the recording medium so that the surface having no separation layer comes in contact with the arc-shaped end of the squeezing member, and the blade for removing the recording material having thermally been fixed onto the separation layer on the recording medium in the control region to be controlled by the control member. Accordingly, the control member first controls the recording medium so that the surface having no separation layer comes in contact with the arc-shaped end of the squeezing member, the adhesive force between the recording material thermally fixed on the separation layer on the recording medium and the separation member. The blade then removes the recording material having a reduced adhesive force between the recording material thermally fixed on the separation layer on the recording medium and the separation member. Consequently, there is no need to apply any additional force to the recording medium with the blade. Further, the recording material can easily be removed from the recording medium without damaging and scratching the recording medium.

### BRIEF DESCRIPTION OF THE DRAWINGS

In the drawings,

FIG. 1 is a front view of a recording material removing device in a first embodiment;

FIG. 2 is a top view of the recording material removing device;

FIG. 3 is a bottom view of the recording material removing device;

FIG. 4 is an explanatory view showing a step (1) in which the recording material removing device transfers a recording material of a recording medium onto a belt-shaped separating member;

FIG. 5 is an explanatory view showing a step (2) in which the recording material removing device transfers the recording material of the recording medium onto the belt-shaped separating member;

FIG. 6 is an explanatory view showing a step (3) in which the recording material removing device transfers the recording material of the recording medium onto the belt-shaped separating member;

FIG. 7 is an explanatory view showing a step (4) in which the recording material removing device transfers the recording material of the recording medium onto the belt-shaped separating member;

FIG. 8 is an explanatory view showing a state where the blade is returned to a downstream side of the belt-shaped separating member;

FIG. 9 is an explanatory view showing a state where the blade is pushed to an upstream side of the belt-shaped separating member;

FIG. 10 is a front view of the recording material removing device for removing a recording material from both surfaces of a recording medium in a second embodiment;

FIG. 11 is an explanatory view showing a step (1) in which the recording material removing device for removing a recording material from both surfaces of a recording medium transfers the recording material of the recording medium onto a belt-shaped separating member;

FIG. 12 is an explanatory view showing a step (2) in which the recording material removing device for removing the recording material from both surfaces of the recording medium transfers the recording material of the recording medium onto the belt-shaped separating member;

FIG. 13 is an explanatory view showing a step (3) in which the recording material removing device for removing the recording material from both surfaces of the recording medium transfers the recording material of the recording medium onto the belt-shaped separating member;

FIG. 14 is an explanatory view showing a step (4) in which the recording material removing device for removing the recording material from both surfaces of the recording medium transfers the recording material of the recording medium onto the belt-shaped separating member;

FIG. 15 is a front view of a recording material removing device in a third embodiment;

FIG. 16 is a top view of the recording material removing device;

FIG. 17 is an explanatory view showing a step (1) in which the recording material removing device removes a recording material of a recording medium;

FIG. 18 is an explanatory view showing a step (2) in which the recording material removing device removes the recording material of the recording medium;

FIG. 19 is an explanatory view showing a step (3) in which the recording material removing device removes the recording material of the recording medium;

FIG. 20 is an explanatory view showing a step (4) in which the recording material removing device removes the recording material of the recording medium;

FIG. 21 is an explanatory view showing a step (5) in which the recording material removing device removes the recording material of the recording medium;

FIG. 22 is an explanatory view showing a step (6) in which the recording material removing device removes the recording material of the recording medium;

FIG. 23 is an explanatory view showing a step (7) in which the recording material removing device removes the recording material of the recording medium;

FIG. 24 is an explanatory view showing a step (8) in which the recording material removing device removes the recording material of the recording medium;

FIG. 25 is an explanatory view showing a step (9) in which the recording material removing device removes the recording material of the recording medium;

FIG. 26 is an explanatory view showing a step (10) in which the recording material removing device removes the recording material of the recording medium;

FIG. 27 is an explanatory view showing a step (11) in which the recording material removing device removes the recording material of the recording medium;

FIG. 28 is a schematic view of an optical sensor constituted of LEDs used in the present invention;

FIG. 29 is an explanatory view showing that a squeezing member and the blade remove the recording material from the recording medium;

FIG. 30 is an enlarged view showing an arc-shaped end of the squeezing member;

FIG. 31 is an explanatory view showing a method of removing a recording material thermally fixed on separation layers on both surfaces of a recording medium in a fourth embodiment;

FIG. 32 is an explanatory view showing another modification of a paper sensor using light; and

FIG. 33 is an explanatory view showing another modification of a paper sensor using a mechanical switch.

### DETAILED DESCRIPTION OF THE PREFERRED EMBODIMENTS

### First Embodiment

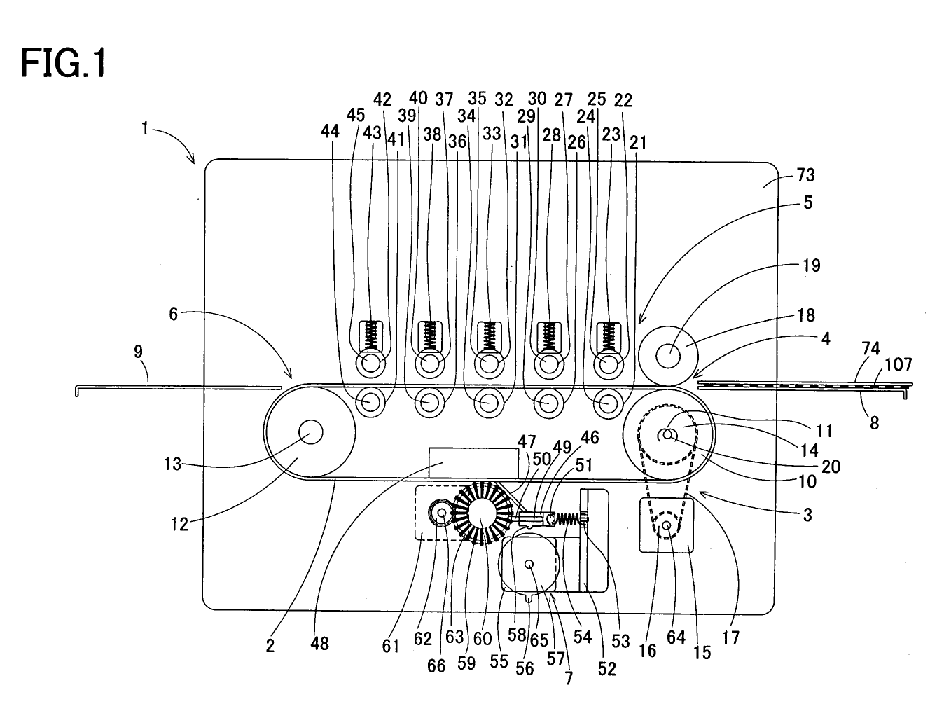

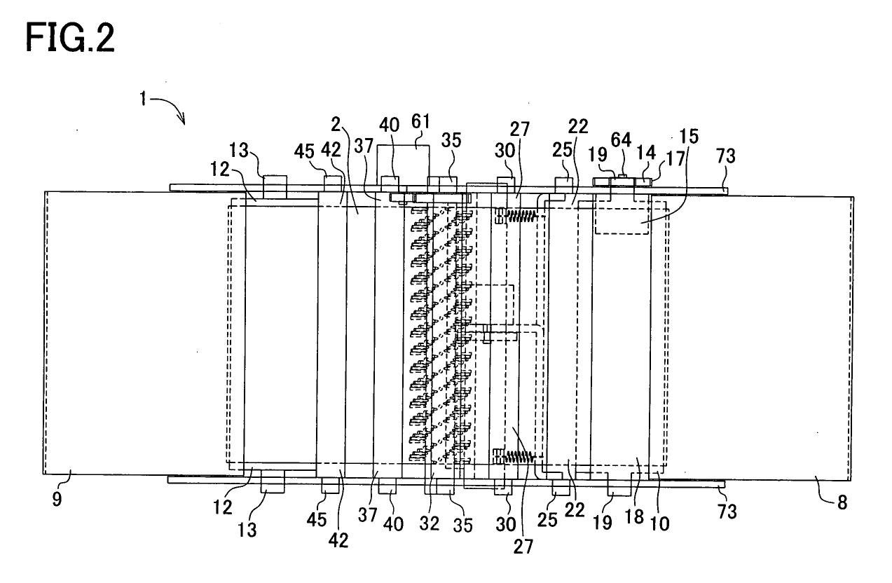

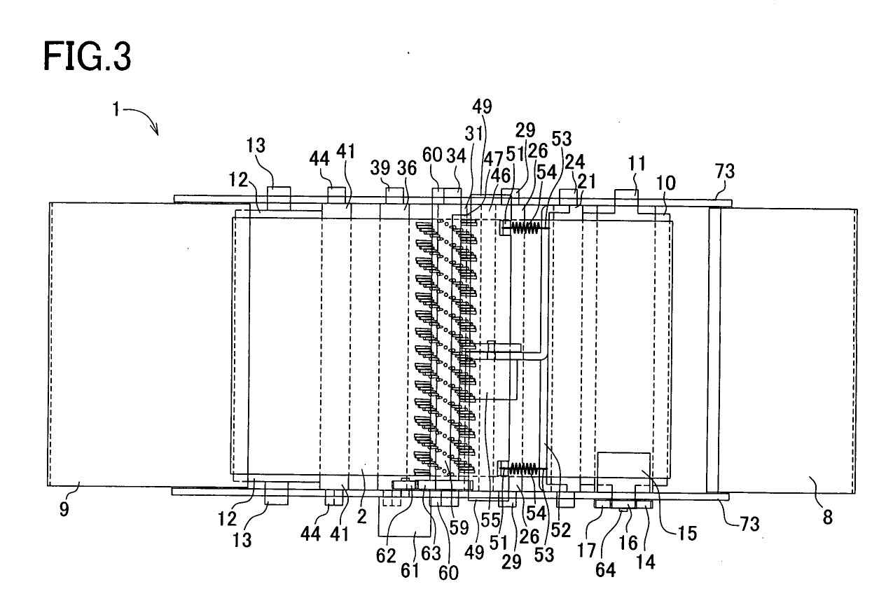

A detailed description of a first preferred embodiment of a recording material removing device for a recording medium embodying the present invention will now be given referring to the accompanying drawings. Firstly, a schematic structure of the recording material removing device in the first embodiment will be explained with reference to FIGS. 1 to 3. FIG. 1 is a front view of the recording material removing device; FIG. 2 is a top view of the recording material removing device; and FIG. 3 is a bottom view of the recording material removing device.

In FIGS. 1 to 3, the recording material removing device 1 principally includes a first conveyance-driving part 3 (at the right-hand center in FIGS. 1 to 3) for driving a first belt-shaped separating member 2 for conveyance; a first bonding part 4 (at the right-hand center in FIGS. 1 to 3) in which the first separating member 2 and a recording medium 74 are bonded by a recording material 107; a nipping-conveying part 5 (at the center in FIGS. 1 to 3) for nipping the first separating member 2 and the recording medium 74 until the recording material 107 bonding them is cooled and solidified; a first recording medium separating part 6 (at the left-hand center in FIGS. 1 to 3) for separating the recording medium 74 from the first separating member 2 while leaving the recording material 107 on the first separating member 2; a first recording material removing part 7 (at the lower center in FIGS. 1 to 3) for removing the recording material 107 remaining on the first separating member 2 from the first separating member 2; a first guide plate 8 (at the right-hand side in FIGS. 1 to 3) and a second guide plate 9 (at the left-hand side in FIGS. 1 to 3) for supporting and guiding the recording medium 74 at respective positions. These components are attached in a fixed or movable state to a frame 73.

Herein, the structure (not shown) of recording medium 74 is explained. The recording medium 74 is formed of a base material and a separation layer bonded or pressed onto the base material. The base material may be for example polyethylene terephthalate, polycarbonate, nylon, fluorocarbon resin, polybutylene terephthalate, acrylate resin, polyphenylene sulfide, polyethersulfone, poly (etheretherketone), polyether imide, or the like, or, reinforced plastic made of the above mentioned materials, polypropylene, polyethylene, or the like, with inorganic materials and fibrous materials added to them, or, pulp sheets such as bond paper, art paper, and coated paper. The separation layer may be for example a material containing at least one of olefin resins such as polyethylene, polypropylene, polybutene, polymethyl butene, polymethyl pentene and fluorocarbon materials. Alternatively, the recording medium 74 may be formed of the base material coated with the separation layer containing at least one of silicon-based materials, fluorine-based materials, or the like. Furthermore, the recording medium 74 may be formed of the base material and separation layer in combination made of a material containing at least one of for example olefin-based materials such as polyethylene, polypropylene, polybutene, polymethyl butene, polymethyl pentene, and fluorine-based materials.

The structure of the first conveyance driving part 3 will be explained first. A first roller 10 is rotatably attached to the frame 73 through a first roller shaft 11 extending from the first roller 10. A second roller 12 is rotatably attached to the frame 73 through a second roller shaft 13 extending from the second roller 12. The belt-shaped separating member 2 made of metal such as 301 stainless steel is wound over these first and second rollers 10 and 12. A first pulley 14 is mounted on the first roller shaft 11 of the first roller 10. A second pulley 16 is mounted on a shaft 64 of a first drive motor 15 attached to the frame 73. These first and second pulleys 14 and 16 are coupled through a first drive belt 17. Placed above the first roller 10 is a pressure roller 18 which presses the first separating member 2 against the first roller 10. The pressure roller 18 is rotatably attached to the frame 73 through a pressure roller shaft 19 extending from the pressure roller 18. With this structure, driving force of the first drive motor 15 is transmitted to the first roller 10 and simultaneously the first separating member 2 is rotated counterclockwise by the pressure roller 18 pressing the first separating member 2 against the first roller 10.

The structure of the first bonding part 4 will be explained below. The first roller 10 internally includes a first heater 20 such as a halogen lamp and serves as a heating roller to heat the first separating member 2, thereby melting or softening the recording material 107 of the recording medium 74 conveyed from the first guide plate 8. The pressure roller 18 placed above the first roller 10 (heating) serves as a support base to press the first separating member 2 and the recording medium 74. With this structure, the first separating member 2 and the recording medium 74 are bonded by the recording material 107. The first separating member 2 and the recording medium 74 bonded by the recording material 107 are pushed in a direction of a tangent line defined by the first roller 10 (heating) and the pressure roller 18 in order to prevent separation of the first separating member 2 and the recording medium 74.

The structure of the nipping-conveying part 5 will be described below. The nipping-conveying part 5 is configured to nip and convey the recording medium 74 bonded to the first separating member 2 by the recording material 107 until the recording material 107 is cooled and solidified to prevent the recording medium 74 from coming off, thereby leaving the recording material 107 unremoved on the recording medium 74. Further, the first separating member 2 and the recording medium 74 bonded by the recording material 107 are nipped by a pair of a first nip-support roller 21 and a first nip-pressure roller 22, while the first nip-pressure roller 22 is pressed against the recording medium 74 by a first tension spring 23. The first nip-support roller 21 is rotatably attached to the frame 73 through a first nip-support roller shaft 24 extending from the first nip-support roller 21. Similarly, the first nip-pressure roller 22 is rotatably attached to the frame 73 through a first nip-pressure roller shaft 25 extending from the first nip-pressure roller 22. The nipping-conveying part 5 includes this structure in a plurality of sets; in the first embodiment, five sets, i.e., a set of the first nip-support roller 21, the first nip-pressure roller 22, the first tension spring 23, the first nip-support roller shaft 24, and the fist nip-pressure roller shaft 25, a set of a second nip-support roller 26, a second nip-pressure roller 27, a second tension spring 28, a second nip-support roller shaft 29, and a second nip-pressure roller shaft 30, a set of a third nip-support roller 31, a third nip-pressure roller 32, a third tension spring 33, a third nip-support roller shaft 34, and a third nip-pressure roller shaft 35, a set of a fourth nip-support roller 36, a fourth nip-pressure roller 37, a fourth tension spring 38, a fourth nip-support roller shaft 39, and a fourth nip-pressure roller shaft 40, and a set of a fifth nip-support roller 41, a fifth nip-pressure roller 42, a fifth tension spring 43, a fifth nip-support roller shaft 44, and a fifth nip-pressure roller shaft 45. With these sets, the nipping-conveying part 5 conveys the first separating member 2 and the recording medium 74, while nipping them in the bonded state by the recording material 107 until the recording material 107 is cooled and solidified.

The structure of the first recording medium separation part 6 will be explained below. When the first separating member 2 and the recording medium 74 in a bonded state by the recording material 107 are conveyed, while cooling and solidifying, to the tangential line portion of the first separating member 2 and the second roller 12, the recording medium 74 turns around and then is separated from the first separating member 2 because of stiffness, while leaving the recording material 107 on the first separating member 2. The recording medium 74 is pushed out onto the second guide plate 9. Further, a separating tab 67 (not shown) for assisting separation is provided near the second roller 12 and the first separating member 2.

The structure of the first recording material removing part 7 will be explained below. A first blade 47 is fixed to a first blade holder 46 so as to be in contact with the first separating member 2. A first supporting member 48 is placed in a position opposite to the first blade 47 with the first separating member 2 being interposed therebetween, thereby supporting the first blade 47 to prevent the first blade 47 from biting into the first separating member 2 while the first blade 47 removes the recording material 107 remaining on the first separating member 2. A first blade holder sliding shaft 49 is provided on either end (upper and lower in FIG. 3) of the first blade holder 46 so that each shaft 49 is slidable in a first blade holder slide groove 50 formed in the frame 73. The first blade holder 46 is pulled back rightwards in FIGS. 1 to 3 by a first elastic member 54 hooked over a first elastic member stopper shaft 51 provided on the first blade holder 46 and a second elastic member stopper shaft 53 provided on a second drive motor supporting frame 52. A second drive motor 55 is mounted on the second drive motor supporting frame 52 fixed to the frame 73. A first disk 57 provided with a first rotating projection 56 is attached to a shaft 65 of the second drive motor 55. Further, upon counterclockwise rotation of the second drive motor 55, the first rotating projection 56 periodically pushes a first projection 58 of the first blade holder 46 leftwards in FIGS. 1 to 3 to make the first sliding shafts 49 of the first blade holder 46 slide in the first slide grooves 50 of the frame 73. While not pushed, the first blade holder 46 is held on the right-hand side in FIGS. 1 to 3. In this way, the first blade 47 is reciprocated with respect to the belt-shaped first separating member 2.

A first cleaning brush 59 for simultaneously cleaning the first blade 47 and the first separating member 2 is rotatably attached to the frame 73 through a first cleaning brush shaft 60 extending from the first cleaning brush 59. The first cleaning brush 59 is rotated when rotation of a third drive motor 61 fixed to the frame 73 is transmitted to a second gear 63 mounted on the first cleaning brush shaft 60 through a first gear 62 mounted on a shaft 66 of the third drive motor 61. The cleaning brush 59 is rotated counterclockwise to clean the first blade 47 and the first separating member 2 at the same time.

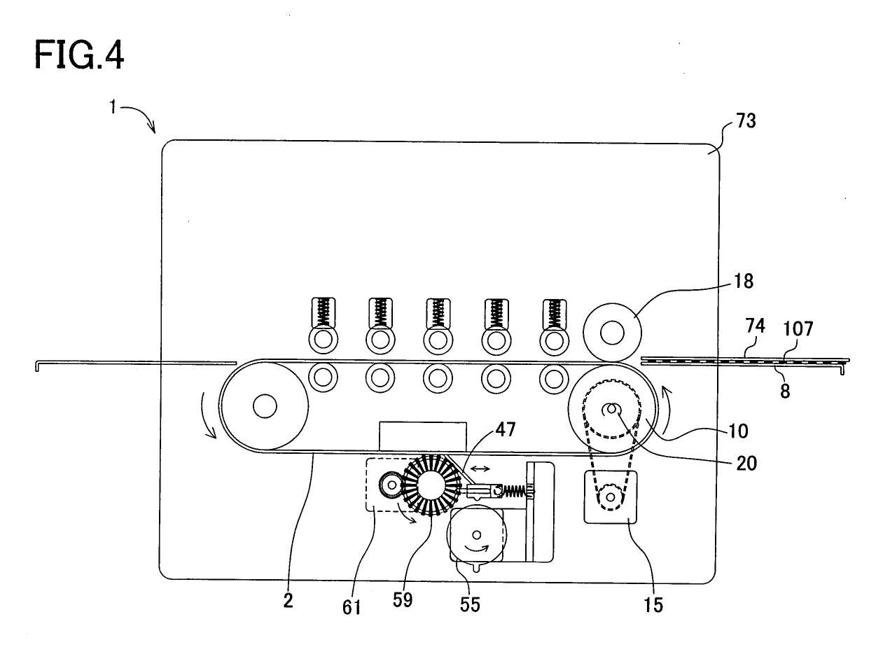

Next, the recording material removing device 1 constructed as above will be explained focusing on movements of the recording medium 74, referring to FIGS. 4 to 7. Herein, the surface of the recording medium 74 with the separation layer on which the recording material 107 has been thermally fixed corresponds to a lower side of the recording medium 74 in the figures.

FIG. 4 is an explanatory view showing a step (1) in which the recording material removing device transfers the recording material of the recording medium onto the belt-shaped separation member. Herein, at the same time when the driving force of the first drive motor 15 is transmitted to the first roller 10, the first separating member 2 is rotated counterclockwise by the pressure roller 18 pressing the first separating member 2 against the first roller 10. The rotation of the second drive motor 55 causes the first blade 47 to reciprocate right and left in the figure in contact with the first separating member 2. The first cleaning brush 59 is rotated counterclockwise by rotation of the third drive motor 61, thereby simultaneously cleaning the first blade 47 and the first separating member 2. The first roller (heating) is saturated at a preset temperature of about 190° C. (changeable from 150° C. to 240° C.) by the first heater 20. The recording medium 74 is on standby on the first guide plate 8, indicating a ready state for conveyance from the first guide plate 8.

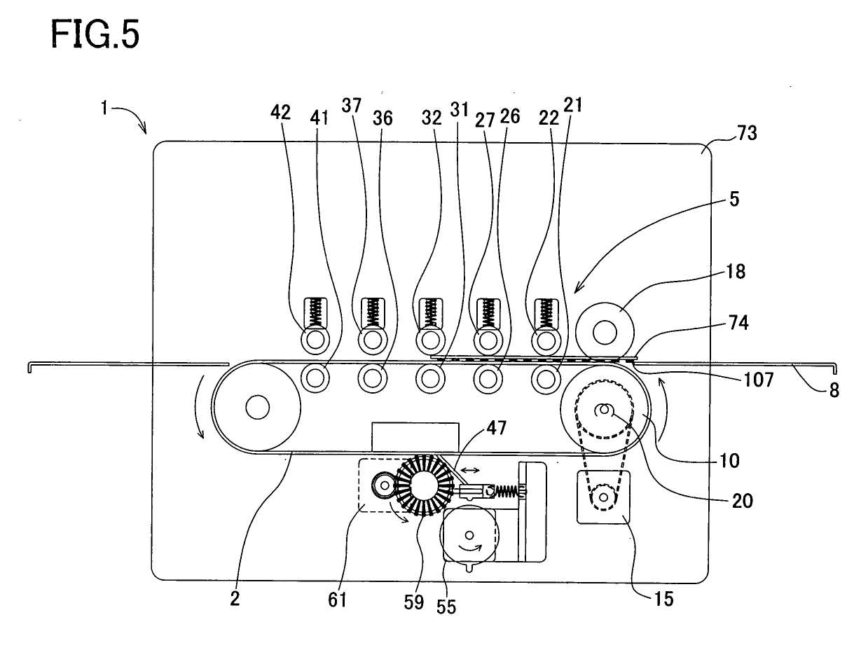

FIG. 5 is an explanatory view showing a step (2) in which the recording material removing device transfers the recording material of the recording medium onto the belt-shaped separating member. The recording medium 74 having been conveyed from the state shown in FIG. 4 is nipped between the first separating member 2 and the pressure roller 18. With the first roller 10 and the pressure roller 18, the first separating member 2 and the recording medium 74 are conveyed under pressure. At this time, the first roller 10 is a heating roller and thus heats the first separating member 2 to melt or soften the recording material 107 of the recording medium 74, so that the recording medium 74 and the first separating member 2 are bonded by the recording material 107. The state is shown where the first separating member 2 and the recording medium 74 bonded by the recording material 107 are nipped and conveyed by the nipping-conveying part 5 until the recording material 107 is cooled and solidified to prevent the recording medium 74 from coming off and the recording material 107 from remaining on the recording medium 74.

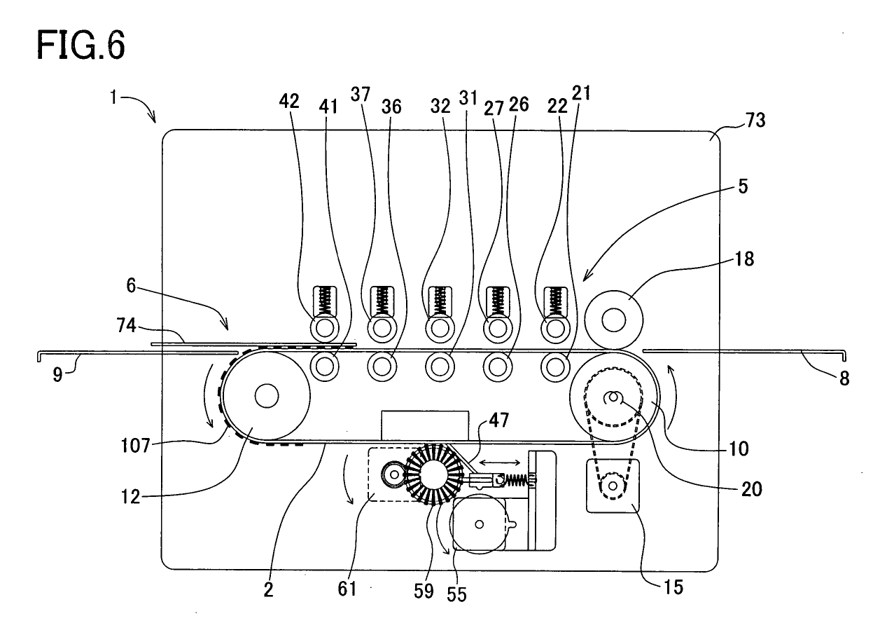

FIG. 6 is an explanatory view showing a step (3) in which the recording material removing device transfers the recording material of the recording medium onto the belt-shaped separating member. It shows that, from the state in FIG. 5, the first separating member 2 and the recording medium 74 nipped by the nipping-conveying part 5 to hold a bonded state bonded by the recording material 107, while cooling and solidifying, are conveyed to a tangent portion of the first separating member 2 to the second roller 12. At that time, because of the recording medium 74 turning around and the stiffness thereof, the recording medium 74 is separated from the first separating member 2 while leaving the recording material 107 on the first separating member 2. Simultaneously, the recording medium 74 begins to be pushed out onto the second guide plate 9. For assisting the separation, the separating tab 67 (not shown) for separating the recording medium 74 from the first separating member 2 is provided near the first separating member 2 and the recording medium 74.

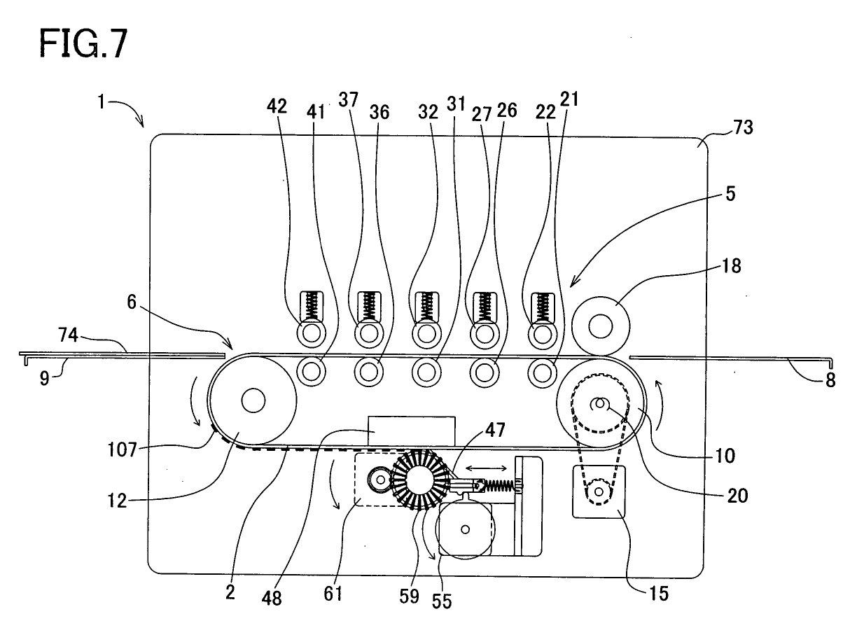

FIG. 7 is an explanatory view showing a step (4) in which the recording material removing device transfers the recording material of the recording medium onto the belt-shaped separating member. The separation is advanced from FIG. 6, the recording material 107 is completely removed from the recording medium 74, and the recording medium 74 is discharged onto the second guide plate 9. It shows the state where the first blade 47 is removing the recording material 107 remaining on the first separating member 2 by reciprocally moving in contact with the first separating member 2. It further shows the state where the first cleaning brush 59 is rotated counterclockwise by rotation of the third drive motor 61, thereby cleaning the first blade 47 and the first separating member 2 at the same time.

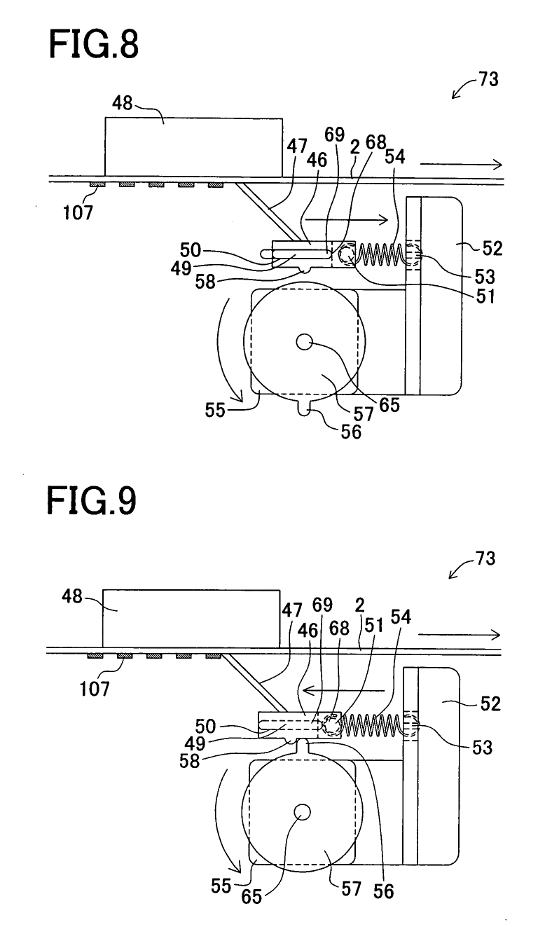

The following explanation will be made on the reciprocating motion of the first blade 47, referring to FIGS. 8 and 9. FIG. 8 is an explanatory view showing a state where the blade has been returned to a downstream side in a rotating direction of the belt-shaped separating member. FIG. 9 is an explanatory view showing a state where the blade is pushed toward an upstream side in the rotating direction of the belt-shaped separating member.

In FIG. 8, the second drive motor 55 is attached to the second drive motor supporting frame 52 fixed to the frame 73, and the first disk 57 formed with the first rotating projection 56 is mounted on the shaft 65 of the second drive motor 55. The second drive motor 55 is rotated counterclockwise. Further, until the first rotating projection 56 comes in contact with the first projection 58 of the first blade holder 46, the first blade holder 46 is pulled back by the first elastic member 54 hooked over the first elastic member stopper shaft 51 of the first blade holder 46 and the second elastic member stopper shaft 53 of the second drive motor supporting frame 52, and a right end 69 of the first blade holder sliding shaft 49 provided in the first blade holder 46 is held in contact with a right end 68 of the first blade holder slide groove 50 of the frame 73.

In FIG. 9, when the first rotating projection 56 comes in contact with the first projection 58 provided in the first blade holder 46, the first blade holder sliding shaft 49 of the first blade holder 46 is caused to slide in the first blade holder slide groove 50 of the frame 73. The first blade holder 46 is moved leftwards in the figure until the first rotating projection 56 is disengaged from the first projection 58 provided in the first blade holder 46. When the first rotating projection 56 is disengaged from the first projection 58 provided in the first blade holder 46, the first blade holder 46 is returned to the state shown in FIG. 8. The motions in FIGS. 8 and 9 are periodically repeated to reciprocate the first blade holder 46.

Since the first blade 47 is attached to the first blade holder 46 so that the first blade 47 is in contact with the first separating member 2, the first blade 47, as with the first blade holder 46, is reciprocated in contact with the surface of the first separating member 2 on which the recording material 107 remains unremoved. Further, when the first blade 47 is reciprocated at a faster moving speed than the moving speed of the first separating member 2, increasing the amount of overlap of the reciprocating motion of the first blade 47, which makes it possible to surely remove the recording material 107 from the first separating member 2. For making the first blade 47 surely remove the recording material 107 and for preventing the first blade 47 from biting into the first separating member 2 during removal of the recording material 107 remaining on the first separating member 2, the first supporting member 48 is provided in a place opposite to the first blade 47 with the first separating member 2 being interposed between them. Since this first supporting member 48 supports the first blade 47 through the first separating member 2, the first blade 47 may be elasticized.

As explained above, in the recording material removing device 1 for the recording medium 74 in the first embodiment, the recording medium 74 is bonded to the first belt-shaped separating member 2 by the recording material 107 melted or softened when the recording medium 74 is brought into contact with the heated first separating member 2, and the recording medium 74 is nipped by the nipping-conveying part 5 until the recording medium 74 is separated from the first separating member 2. Accordingly, there is an effect of solving the problem that the recording medium 74 comes off the first separating member 2 due to warping of the recording medium 74 before the recording material 107 is cooled and solidified, which causes cobwebbing of the unsolidified recording material 107 between the first separating member 2 and the recording medium 74 and remains on the recording medium 74.

It is further arranged such that the recording medium 74 is separated from the first separating member 2 after the recording material 107 is cooled and solidified. Accordingly, there is an effect of solving the problem that the unsolidified recording material 107 causes cobwebbing between the first separating member 2 and the recording medium 74 and remains on the recording medium 74.

Further, the recording material removing device 1 is arranged such that the first separating member 2 and the recording medium 74 are nipped by the nipping-conveying part 5 until the recording medium 74 is separated from the first separating member 2, and then the recording medium 74 is separated from the first separating member 2 after the recording material 107 is cooled to a glass-transition temperature (Tg) or less. Accordingly, complete cooling and solidifying of the recording material 107 makes it possible to solve the problem that the unsolidified recording material 107 causes cobwebbing between the first separating member 2 and the recording medium 74 and remains on the recording medium 74.

Since the recording material removing device 1 is arranged such that the nipping-conveying part 5 is constituted of rollers, a load on the first conveyance driving part 3 which drives the first separating member 2 can be reduced. This provides an effect of reducing the cost of the recording material removing device 1 and also an effect of cooling the recording material 107.

In the recording material removing device 1, furthermore, the recording medium 74 is drawn, in a bonded state to the first separating member 2 heated to melt and soften the recording material 107, along the tangent line to the first roller 10 (heating). Accordingly, there is an effect of preventing separation caused by displacement of the recording medium 74 from the first separating member 2 and by warping of the recording medium 74.

The recording material removing device 1 for recording medium 74 in the first embodiment includes: the first blade 47 in contact with the surface of the first separating member 2 to remove the recording material 107; and the first supporting member 48 placed in the position opposite to the first blade 47 with the first separating member 2 being interposed therebetween. The first blade 47 is reciprocated with respect to the first separating member 2 while pressing against the first supporting member 48 through the first separating member 2. Accordingly, the areas where the recording material 107 is removed from the first separating member 2 are overlapped and thus the blade 47 can reliably remove the recording material 107 from the first separating member 2. This provides an effect of eliminating the problem that the recording material 107 could not be removed from the area where removing has been missed once.

The recording material removing device 1 is arranged to reciprocate the first blade 47 along a traveling direction of the first separating member 2. This makes it possible to reciprocate the first blade 47 without separating from the first separating member 2 even during a reciprocating motion of the first blade 47 and therefore to facilitate a mechanism.

In the recording material removing device 1, the reciprocating motion of the first blade 47 is faster than the moving speed of the first separating member 2, so that the areas of the first separating member 2 from which the first blade 47 removes the recording material 107 are overlapped. This makes it possible to surely remove the recording material 107 from the first separating member 2 and prevent the generation of the unremoved recording material 107 caused by a slow reciprocating motion of the first blade 47.

In the recording material removing device 1, the first blade 47 is elasticized to absorb a clearance between the first separating member 2 and the first blade 47, thereby ensuring removal of the recording material 107 from the first separating member 2.

The recording material removing device 1 includes the first blade 47 in contact with the first separating member 2 to remove the recording material 107, the first supporting member 48 placed in the position opposite to the first blade 47 with the first separating member 2 being interposed therebetween, and the first cleaning brush 59 for simultaneously cleaning the first blade 47 and the first separating member 2 while the first blade 47 removes the recording material 107 from the first separating member 2 by pressing against the first supporting member 48 through the first separating member 2. Accordingly, the first cleaning brush 59 can clean the first blade 47 just after the first blade 47 removes the recording material 107. Thus, there is an effect of solving the problem that the recording material 107 adheres to the first blade 47 and deteriorates the capacity for removing the recording material 107.

Furthermore, even when the recording material 107 disperses forward of the first blade 47 when the first blade 47 removes the recording material 107 from the first separating member 2, the first cleaning brush 59 cleans the first blade 47 and the first separating member 2 just after dispersion. Accordingly, the problem that the recording material 107 is caught between the first separating member 2 and the first blade 47 and remains unremoved can be solved.

The recording material removing device 1 includes the cleaning member constituted of a rotating brush. A low-cost cleaning member can be provided to clean the first blade 47 for removing the recording material 107 and the first separating member 2 at the same time by a simple structure.

### Second Embodiment

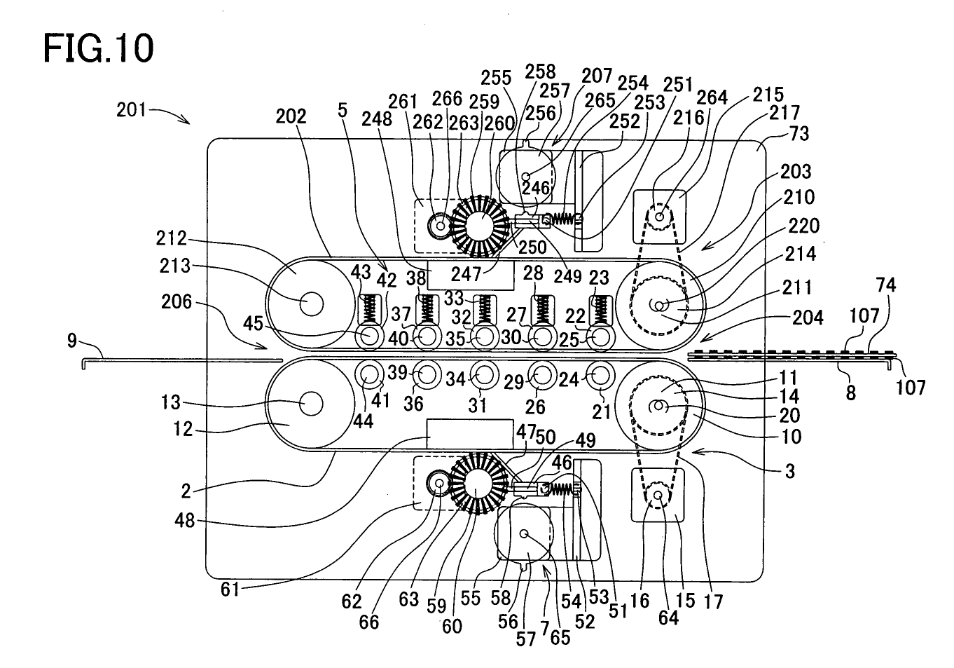

In a second embodiment, a recording material removing device for removing a recording material from a recording medium both surfaces of which the recording material has thermally been fixed will be explained, referring to the accompanying drawings. A schematic structure of the recording material removing device in the second embodiment will be described first with reference to FIG. 10. FIG. 10 is a front view of the recording material removing device for removing the recording material from both surfaces of the recording medium. It is to be noted that the members having the same structures as those in the first embodiment are assigned the same reference numerals.

In FIG. 10, a recording material removing device 201 principally includes: a first conveyance driving part 3 (at the lower right-hand center in FIG. 10) for driving a first belt-shaped separating member 2 for conveyance; a second conveyance driving part 203 (at the upper right-hand center in FIG. 10) for driving a second belt-shaped separating member 202 for conveyance; a second bonding part 204 (at the right-hand center in FIG. 10) in which the second separating member 202 and a recording medium 74 are bonded by a recording material 107; a nipping-conveying part 5 (at the center in FIG. 10) for nipping the first separating member 2 and the recording medium 74, and, the second separating member 202 and the recording medium 74, until the recording material 107 bonding them is cooled and solidified; a second recording medium separating part 206 (at the left-hand center in FIG. 10) for separating the recording medium 74 from the first separating member 2 while leaving the recording material 107 on the first separating member 2 and simultaneously separating the recording medium 74 from the second separating member 202 while leaving the recording material 107 on the second separating member 202; a first recording material removing part 7 (at the lower center in FIG. 10) for removing the recording material 107 remaining on the first separating member 2 from the first separating member 2; a second recording material removing part 207 (at the upper center in FIG. 10) for removing the recording material 107 remaining on the second separating member 2 from the second separating member 2; and a first guide plate 8 (at the right-hand side in FIG. 10) and a second guide plate 9 (at the left-hand side in FIG. 10) for supporting and guiding the recording medium 74 at respective positions. These components are attached in a fixed or movable state to a frame 73.

The structure of the first belt-shaped conveyance driving part 3 is the same as in the first embodiment where it is explained in detail, and it is therefore omitted herein (however, the pressure roller 18 is replaced by a third roller 210).

The structure of the second conveyance driving part 203 for driving the second separating member 202 for conveyance will be explained below. The third roller 210 (heating) is rotatably attached to a frame 73 through a third roller shaft 211 extending form the third roller 210. A fourth roller 212 is rotatably attached to the frame 73 through a fourth roller shaft 213 extending from the fourth roller 212. The second belt-shaped separating member 202 made of metal such as 301 stainless steel is wound over these third and fourth rollers 210 and 212. A third pulley 214 is mounted on the third roller shaft 211 of the third roller 210. A fourth pulley 216 is mounted on a shaft 264 of a fourth drive motor 215 attached to the frame 73. These third and fourth pulleys 214 and 216 are coupled through a second drive belt 217. Placed below the third roller 210 is a first roller 10 which presses the second belt-shaped separating member 202 against the third roller 210. The first roller 10 is rotatably attached to the frame 73 through a first roller shaft 11 extending from the first roller 10. With this structure, driving force of the fourth drive motor 215 is transmitted to the third roller 210 and simultaneously the third roller 210 and the first roller 10 press against the second separating member 202, thereby rotating the second separating member 202 clockwise.

The structure of the second bonding part 204 will be described below. The first roller 10 internally includes a first heater 20 such as a halogen lamp and serves as a heating roller to heat the first separating member 2. The third roller 210 internally includes a second heater 220 such as a halogen lamp and serves as a heating roller to heat the second separating member 202. The first and second separating member 2 and 202 nip and heat the recording material 107 thermally fixed on both surfaces of the recording medium 74 having been conveyed from the first guide plate 8 to melt or soften, and the first roller 10 (heating) and the third roller 210 (heating) press the first separating member 2 and the recording medium 74 and the second separating member 202. With this structure, the first separating member 2 and the recording medium 74 and the second separating member 202 are bonded by the recording material 107. The first separating member 2 and the recording medium 74 and the second separating member 202 bonded by the recording material 107 are pushed in a direction tangent to the first roller 10 (heating) and the third roller 210 (heating) in order to prevent separation of the first separating member 2 and the recording medium 74 and the second separating member 202.

The structure of the nipping-conveying part 5 will be described below. The nipping-conveying part 5 is configured to nip and convey the recording medium 74 bonded to the first separating member 2 and the second separating member 202 by the recording material 107 until the recording material 107 is cooled and solidified to prevent the recording medium 74 from coming off, thereby leaving the recording material 107 unremoved on the recording medium 74. Further, the first separating member 2 and the recording medium 74 and the second separating member 202 bonded by the recording material 107 are nipped by a pair of a first nip-support roller 21 and a first nip-pressure roller 22, while the first nip-pressure roller 22 is pressed against the recording medium 74 by a first tension spring 23. The first nip-support roller 21 is rotatably attached to the frame 73 through a first nip-support roller shaft 24 extending from the first nip-support roller 21. Similarly, the first nip-pressure roller 22 is rotatably attached to the frame 73 through a first nip-pressure roller shaft 25 extending from the first nip-pressure roller 22. The nipping-conveying part 5 includes this structure in a plurality of sets; in the second embodiment, five sets, i.e., a set of the first nip-support roller 21, the first nip-pressure roller 22, the first tension spring 23, the first nip-support roller shaft 24, and the fist nip-pressure roller shaft 25, a set of a second nip-support roller 26, a second nip-pressure roller 27, a second tension spring 28, a second nip-support roller shaft 29, and a second nip-pressure roller shaft 30, a set of a third nip-support roller 31, a third nip-pressure roller 32, a third tension spring 33, a third nip-support roller shaft 34, and a third nip-pressure roller shaft 35, a set of a fourth nip-support roller 36, a fourth nip-pressure roller 37, a fourth tension spring 38, a fourth nip-support roller shaft 39, and a fourth nip-pressure roller shaft 40, and a set of a fifth nip-support roller 41, a fifth nip-pressure roller 42, a fifth tension spring 43, a fifth nip-support roller shaft 44, and a fifth nip-pressure roller shaft 45. With these sets, the nipping-conveying part 5 conveys the first separating member 2 and the recording medium 74 and the second separating member 202, while nipping them in the bonded state by the recording material 107 until the recording material 107 is cooled and solidified.

The structure of the second recording medium separating part 206 will be explained below. When the first separating member 2 and the second separating member 202 are bonded to the recording medium 74 by the recording material 107 in the second bonding part 204 and are conveyed in a bonded state by the nipping-conveying part 5, while cooling and solidifying, to the tangent portion of the second roller 12 and the fourth roller 212, the recording medium 74 turns around and then is separated from the first separating member 2 and the second separating member 202 at the same time because of stiffness, while leaving the recording material 107 on the first separating member 2 and the second separating member 202. The recording medium 74 is pushed out onto the second guide plate 9. Further, separating tabs 67 (not shown) for assisting separation are provided one near the second roller 12 and the first separating member 2 and one near the fourth roller 212 and the second separating member 202 respectively.

The structure of the first recording material removing part 7 is the same as in the first embodiment where it is explained in detail, and therefore it is omitted herein.

The structure of the second recording material removing part 207 will be described below. A second blade 247 is fixed to second blade holder 246 so as to be in contact with the second separating member 202. A second supporting member 248 is placed in a position opposite to the second blade 247 with the second separating member 202 being interposed therebetween, thereby supporting the second blade 247 to prevent the second blade 247 from biting into the second separating member 202 while the second blade 247 removes the recording material 107 from the second separating member 202. A second blade holder sliding shaft 249 is provided on either end of the second blade holder 246 so that each shaft 249 is slidable in a second blade holder slide groove 250 formed in the frame 73. The second blade holder 246 is pulled back rightwards in FIG. 10 by a fourth elastic member 254 hooked over a third elastic member stopper shaft 251 provided in the second blade holder 246 and a fourth elastic member stopper shaft 253 provided in a fifth drive motor supporting frame 252. A fifth drive motor 255 is mounted on the fifth drive motor supporting frame 252 fixed to the frame 73. A second disk 257 provided with a second rotating projection 256 is attached to a shaft 265 of the fifth drive motor 255. Further, upon counterclockwise rotation of the fifth drive motor 255, the second rotating projection 256 periodically pushes a second projection 258 provided in the second blade holder 246 leftwards in FIG. 10 to make the second sliding shafts 249 of the second blade holder 246 slide in the second slide grooves 50 of the frame 73. While not pushed, the second blade holder 246 is held on the right-hand side in FIG. 10. In this way, the second blade 247 is reciprocated with respect to the second separating member 202.

A second cleaning brush 259 for simultaneously cleaning the second blade 247 and the second separating member 202 is rotatably attached to the frame 73 through a second cleaning brush shaft 260 extending from the second cleaning brush 259. The second cleaning brush 259 is rotated when rotation of a sixth drive motor 261 fixed to the frame 73 is transmitted to a fourth gear 263 mounted on the second cleaning brush shaft 260 through a third gear 262 mounted on a shaft 266 of the sixth drive motor 261. The second cleaning brush 259 is rotated counterclockwise to clean the second blade 247 and the second separating member 202 at the same time.

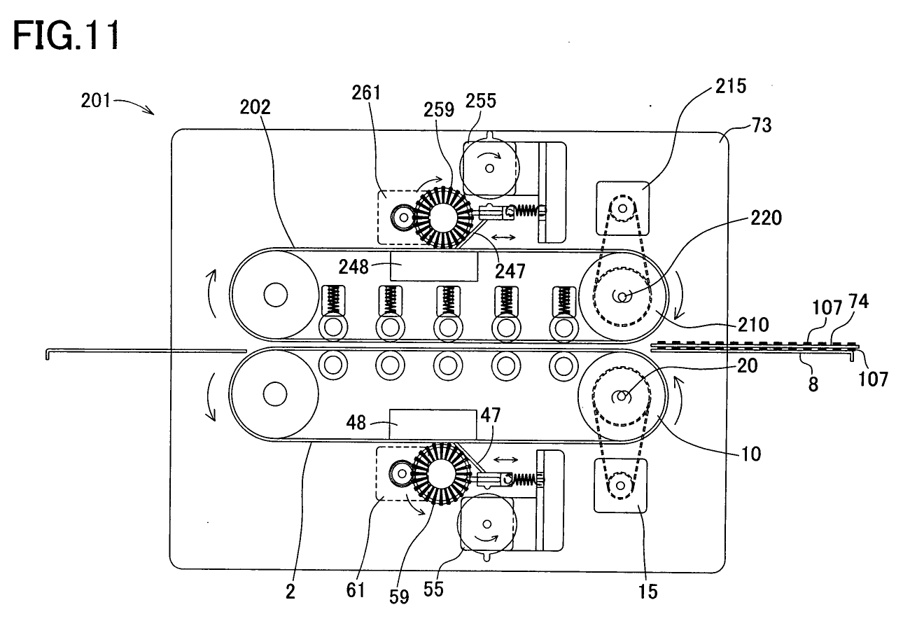

Next, the recording material removing device 201 constructed as above will be explained focusing on movements of the recording medium 74, referring to FIGS. 11 to 14. Herein, the surfaces of the recording medium 74 with the separation layers on which the recording material 107 has been thermally fixed correspond to both sides of the recording medium 74 in the figures.

FIG. 11 is an explanatory view showing a step (1) in which the recording material removing device for removing the recording material from both surfaces of the recording medium transfers the recording material of the recording medium onto the belt-shaped separation member. Herein, at the same time when the driving force is transmitted to the first roller 10, the first separating member 2 is rotated counterclockwise by the third roller 210 pressing the first separating member 2 against the first roller 10. The rotation of the second drive motor 55 causes the first blade 47 to reciprocate right and left in the figure in contact with the first separating member 2. The first cleaning brush 59 is rotated counterclockwise by rotation of the third drive motor 61, thereby simultaneously cleaning the first blade 47 and the first separating member 2. The first roller (heating) is saturated at a preset temperature of about 190° C. (changeable from 150° C. to 240° C.) by the first heater 20.

Moreover, at the same time when the driving force of the fourth drive motor 215 is transmitted to the third roller 210, the second separating member 202 is rotated clockwise by the first roller 10 pressing the second separating member 202 against the third roller 210. The rotation of the fifth drive motor 255 causes the second blade 247 to reciprocate right and left in the figure in contact with the second separating member 202. The second cleaning brush 259 is rotated clockwise by rotation of the sixth drive motor 261, thereby simultaneously cleaning the second blade 247 and the second separating member 202. The third roller 210 (heating) is saturated at a preset temperature of about 190° C. (changeable from 150° C. to 240° C.) by the second heater 220.

The recording medium 74 is on standby on the first guide plate 8, indicating a ready state for conveyance from the first guide plate 8.

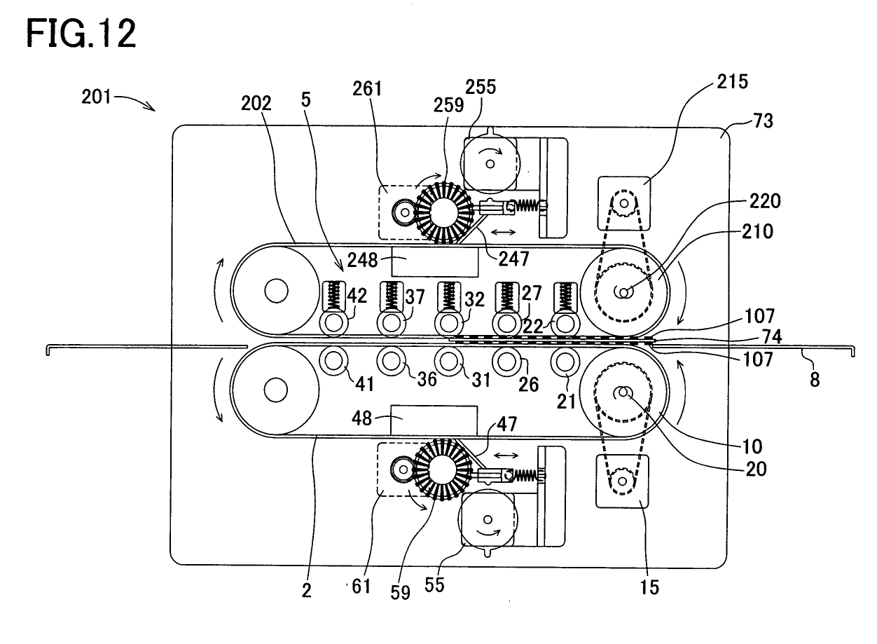

FIG. 12 is an explanatory view showing a step (2) in which the recording material removing device for removing the recording material from both surfaces of the recording medium transfers the recording material of the recording medium onto belt-shaped separating member. The recording medium 74 having been conveyed from the state shown in FIG. 11 is nipped between the first separating member 2 and the second separating member 202. With the first roller 10 and the third roller 210, the first separating member 2 and the recording medium 74 and the second separating member 202 are conveyed under pressure. At this time, the first roller 10 is a heating roller and thus heats the first separating member 2 and simultaneously the third roller 210 is a heating roller and thus heats the second separating member 202 to melt or soften the recording material 107 on both surfaces of the recording medium 74, so that the first separating member 2 and the recording medium 74 and the second separating member 202 are bonded by the recording material 107. The state is shown where the first separating member 2 and the recording medium 74 and the second separating member 202 bonded by the recording material 107 are nipped and conveyed by the nipping-conveying part 5 until the recording material 107 is cooled and solidified to prevent the recording medium 74 from coming off and the recording material 107 remaining on the recording medium 74.

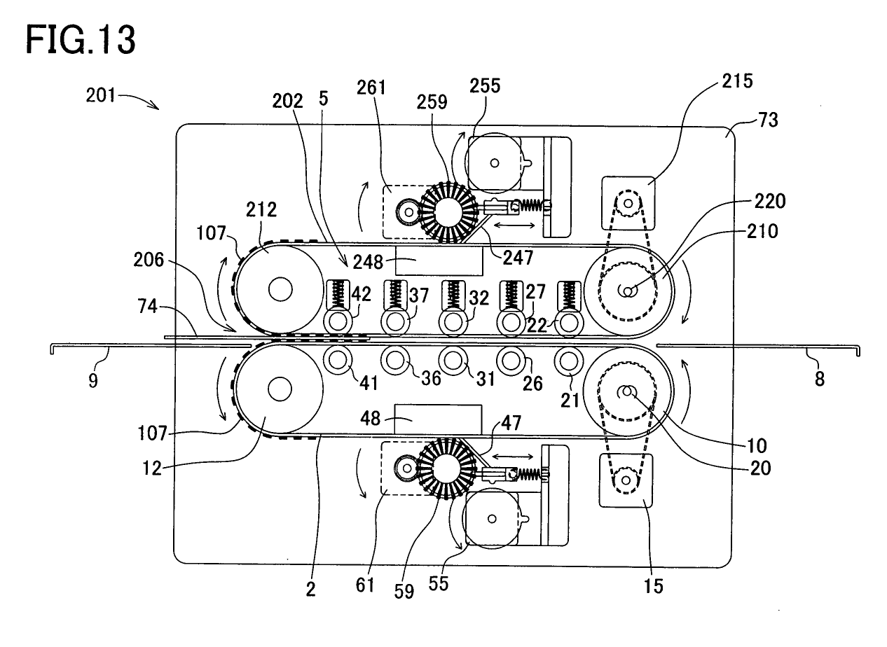

FIG. 13 is an explanatory view showing a step (3) in which the recording material removing device for removing the recording material from both surfaces of the recording medium transfers the recording material of the recording medium onto the belt-shaped separating member. It shows that, from the state in FIG. 12, the first separating member 2 and the recording medium 74 and the second separating member 202 nipped by the nipping-conveying part 5 to hold a bonded state by the recording material 107, while cooling and solidifying, are conveyed to a tangent portion to the second roller 12 and the fourth roller 212. At that time, because of the recording medium 74 turning around and the stiffness thereof, the recording medium 74 is separated from the first separating member 2 while leaving the recording material 107 on the first separating member 2 and also the recording medium 74 is separated from the second separating member 202 while leaving the recording material 107 on the second separating member 202. Simultaneously, the recording medium 74 begins to be pushed out onto the second guide plate 9. For assisting the separation, the separation tabs 67 (not shown) are provided one near the second roller 12 and the first separating member 2 and one near the fourth roller 212 and the second separating member 202 respectively.

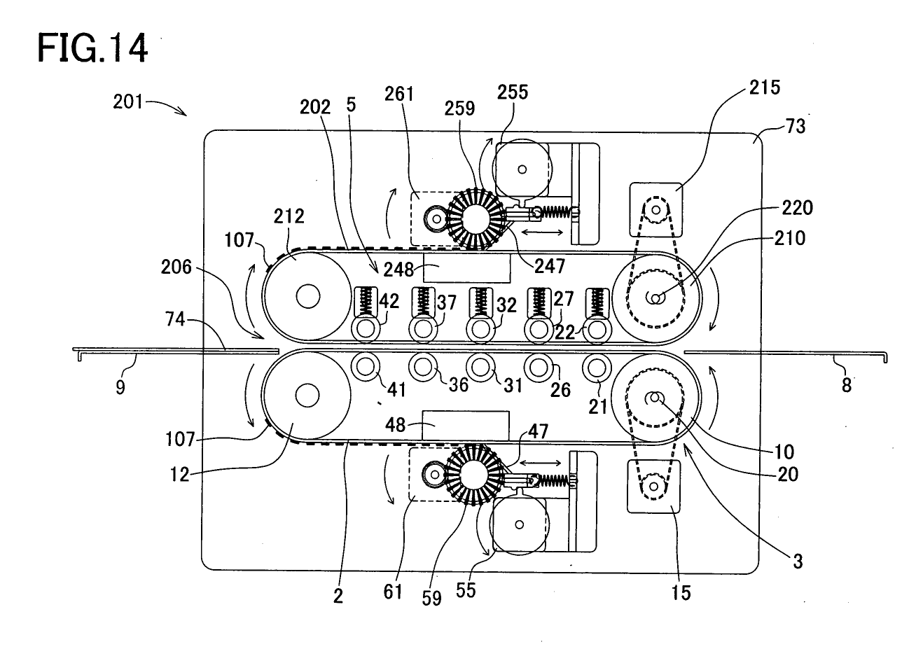

FIG. 14 is an explanatory view showing a step (4) in which the recording material removing device for removing the recording material from both surfaces of the recording medium transfers the recording material of the recording medium onto the belt-shaped separating member. The separation is advanced from FIG. 13, the recording material 107 is completely removed from the recording medium 74, and the recording medium 74 is conveyed onto the second guide plate. It shows the state where the first blade 47 is removing the recording material 107 remaining on the first separating member 2 by reciprocally moving in contact with the first separating member 2 and simultaneously the second blade 247 is removing the recording material 107 remaining on the second separating member 202 by reciprocally moving in contact with the second separating member 202. It further shows the state where the first cleaning brush 59 is rotated counterclockwise by rotation of the third drive motor 61, cleaning the first blade 47 and the first separating member 2 at the same time, and simultaneously the second cleaning brush 259 is rotated clockwise by rotation of the sixth motor 261, cleaning the second blade 247 and the second separating member 202 at the same time.

As explained above, the recording material removing device 201 for the recording medium 74 in the second embodiment includes the first and second separating members 2 and 202 so that the recording medium 74 is nipped and conveyed by the first and second separating members 2 and 202. Accordingly, the recording medium 74 is face-nipped from both sides. This makes it possible to solve the problem that the recording medium 74 comes off from the first separating member 2 or the second separating member 202 and the unsolidified recording material 107 causes cobwebbing between the first separating member 2 and the recording medium 74 or between the second separating member 202 and the recording medium 74 and thus remains on the recording medium 74.

Further, it is arranged such that the recording medium 74 is separated from the first and second separating members 2 and 202 after the recording material 74 is cooled and solidified. Accordingly, the problem that the unsolidified recording material 74 causes cobwebbing between the first separating member 2 or the second separating member 202 and the recording medium 74 and remains on the recording medium 74. Since the recording material 107 thermally fixed on the recording medium 74 can be removed from both surfaces thereof at the same time, the recording material removing device 201 for removing the recording material 74 from both surfaces can be made at low cost. Even the recording medium 74 having one surface on which the recording material 107 has thermally been fixed can be charged into the recording material removing device 201 regardless of either surface, front or back.

In the recording material removing device 201, the recording medium 74 is nipped and conveyed by the first and second separating members 2 and 202, and the recording medium 74 is separated from the first and second separating members 2 and 202 after the recording material 107 is cooled to a glass-transition temperature (Tg) or less. Accordingly, complete cooling and solidifying of the recording material 107 makes it possible to solve the problem that the unsolidified recording material 107 causes cobwebbing between the first separating member 2 or the second separating member 202 and the recording medium 74 and remains on the recording medium 74.

Since the recording material removing device 201 is arranged such that the first separating member 2 and the second separating member 202 are further nipped by the rollers, a load on the first and third conveyance driving parts 3 and 203 which drive the first and second separating members 2 and 202 can be reduced. This provides an effect of reducing the cost of the recording material removing device 201 and also an effect of cooling the recording material 107.

In the recording material removing device 201, furthermore, the recording medium 74 is drawn, in a bonded state to the first and second separating members 2 and 202 heated to melt or soften the recording material 107, along the tangent line to the first roller 10 (heating) and the third roller 210 (heating). Consequently, there is an effect of preventing separation caused by displacement of the recording medium 74 from the first separating member 2 or the second separating member 202 and by warping of the recording medium 74.

The recording material removing device 201 for the recording medium 74 in the second embodiment includes: the first blade 47 in contact with the surface of the first separating member 2; and the first supporting member 48 placed in the position opposite to the first blade 47 with the first separating member 2 being interposed therebetween. The first blade 47 is reciprocated with respect to the first 22 while pressing against the first supporting member 48 through the first separating member 2. Accordingly, the areas where the recording material 107 is removed from the first separating member 2 are overlapped and thus the blade 47 can reliably remove the recording material 107 from the first separating member 2. This provides an effect of eliminating the problem that the recording material 107 could not be removed from the area where removing has been missed once.

The recording material removing device 201 further includes: the second blade 247 in contact with the surface of the second separating member 202 to remove the recording material 107; and the second supporting member 248 placed in the position opposite to the second blade 247 with the second separating member 202 being interposed therebetween. The second blade 247 is reciprocated with respect to the second separating member 202 while pressing against the second supporting member 248 through the second separating member 202. Accordingly, the areas where the recording material 107 is removed from the second separating member 202 are overlapped and thus the blade 247 can reliably remove the recording material 107 from the second separating member 202. This provides an effect of eliminating the problem that the recording material 107 could not be removed from the area where removing has been missed once.

The recording material removing device 201 is arranged to reciprocate the first blade 47 along a traveling direction of the first separating member 2. This makes it possible to reciprocally move the first blade 47 without separating the first blade 47 from the first separating member 2 even during a reciprocating motion of the first blade 47 and therefore to facilitate a mechanism.

Further, the second blade 247 is reciprocated along a traveling direction of the second separating member 202. This makes it possible to reciprocate the second blade 247 without separating the second blade 247 from the second separating member 202 even during a reciprocating motion of the second blade 247 and therefore to facilitate a mechanism.

In the recording material removing device 201, the reciprocating motion of the first blade 47 is faster than the moving speed of the first separating member 2, so that the areas of the first separating member 2 from which the first blade 47 removes the recording material 107 are overlapped. This makes it possible to surely remove the recording material 107 from the first separating member 2 and prevent the generation of the unremoved recording material 107 caused by a slow reciprocation of the first blade 47.

Further, the reciprocation of the second blade 247 is faster than the moving speed of the second separating member 202, so that the areas of the second separating member 202 from which the second blade 247 removes the recording material 107 are overlapped. This makes it possible to surely remove the recording material 107 from the second separating member 202 and prevent the generation of the unremoved recording material 107 caused by a slow reciprocation of the second blade 247.

In the recording material removing device 201, the first blade 47 is elasticized to absorb a clearance between the first separating member 2 and the first blade 47, thereby ensuring removal of the recording material 107 from the first separating member 2.

Furthermore, the second blade 247 is elasticized to absorb a clearance between the second separating member 202 and the second blade 247, thereby ensuring removal of the recording material 107 from the second separating member 202.

The recording material removing device 201 includes the first blade 47 in contact with the first separating member 2 to remove the recording material 107, the first supporting member 48 in the position opposite to the first blade 47 with the first separating member 2 being interposed therebetween, and the first cleaning brush 59 for simultaneously cleaning the first blade 47 and the first separating member 2 while the first blade 47 removes the recording material 107 from the first separating member 2 by pressing against the first supporting member 48 through the first separating member 2. Accordingly, the first cleaning brush 59 can clean the first blade 47 just after the first blade 47 removes the recording material 107. Thus, there is an effect of solving the problem that the recording material 107 adheres to the first blade 47 and deteriorates the capacity for removing the recording material 107.

Further, the recording material removing device 201 includes the second blade 247 in contact with the surface of the second separating member 202 to remove the recording material 107 and the second supporting member 248 placed in the position opposite to the second blade 247 with the second separating member 202 being interposed therebetween, and the second cleaning brush 259 for simultaneously cleaning the second blade 247 and the second separating member 202 while the second blade 247 removes the recording material 107 from the second separating member 202 by pressing against the second supporting member 248 through the second separating member 202. Accordingly, the second cleaning brush 259 can clean the second blade 247 just after the second blade 247 removes the recording material 107. Thus, there is an effect of solving the problem that the recording material 107 adheres to the second blade 247 and deteriorates the capacity for removing the recording material 107.

Furthermore, even when the recording material 107 disperses forward of the first blade 47 when the first blade 47 removes the recording material 107 from the first separating member 2, the first cleaning brush 59 cleans the first blade 47 and the first separating member 2 just after dispersion. Accordingly, the problem that the recording material 107 is caught between the first separating member 2 and the first blade 47 and remains unremoved can be solved. The recording material removing device 201 for recording medium can provide an equal effect.

Furthermore, even when the recording material 107 disperses forward of the second blade 247 when the second blade 247 removes the recording material 107 from the second separating member 202, the second cleaning brush 259 cleans the second blade 247 and the second separating member 202 just after dispersion. Accordingly, the problem that the recording material 107 is caught between the second separating member 202 and the second blade 247 and remains unremoved can be solved.

The recording material removing device 201 includes the cleaning member constituted of a rotating brush. A low-cost cleaning member can be provided to clean the first blade 47 for removing the recording material 107 and the first separating member 2 at the same time by a simple structure.

Since the cleaning member is constituted of a rotating brush, a low-cost cleaning member can be provided to clean the second blade 247 for removing the recording material 107 and the second separating member 202 at the same time by a simple structure.

### Third Embodiment

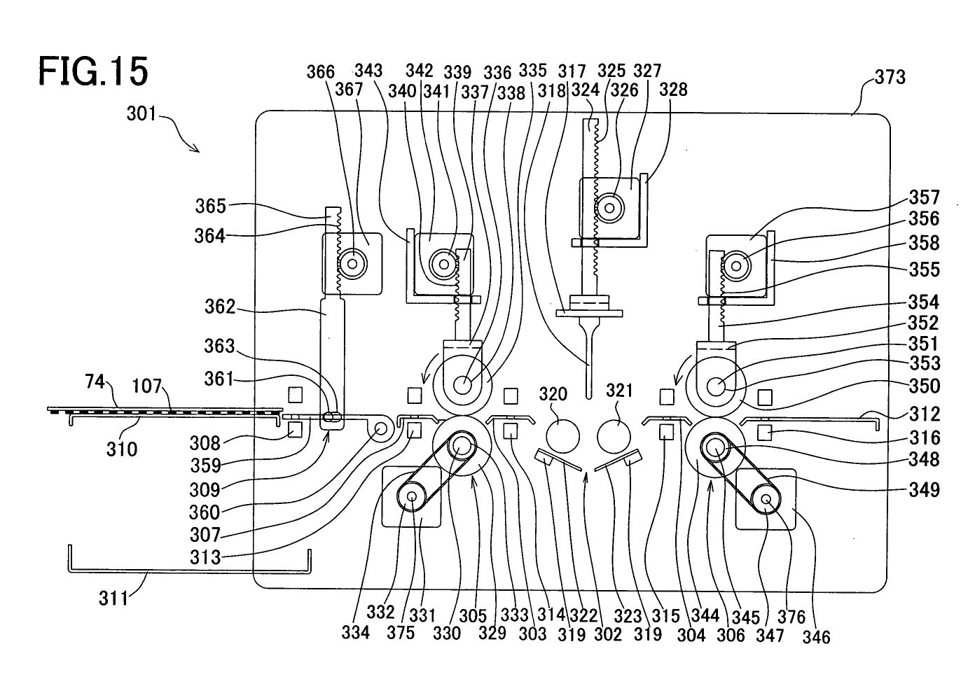

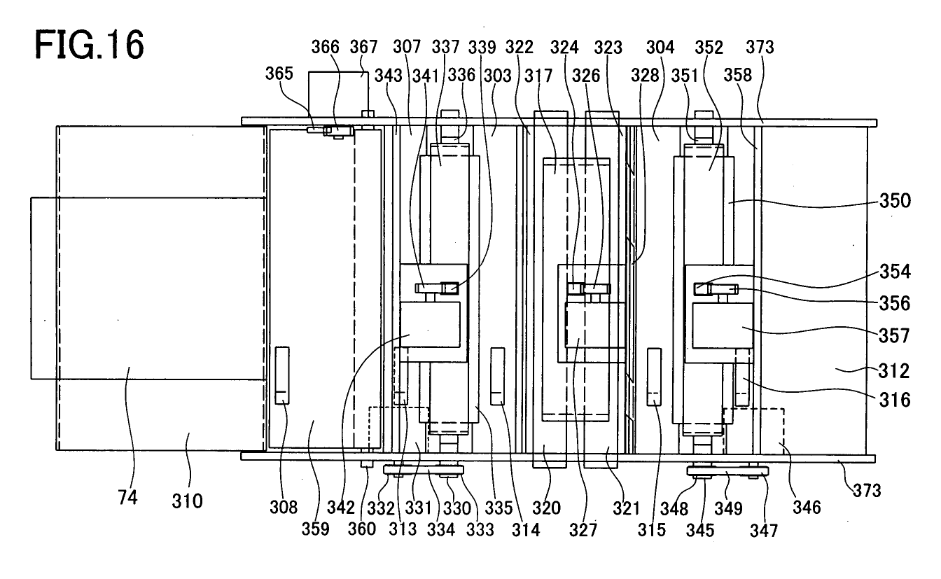

In a third embodiment, a recording material removing device for a recording medium embodying the present invention will be explained in detail, referring the drawings. A schematic structure of the recording material removing device for the recording medium in the third embodiment will be described first with reference to FIGS. 15 and 16. FIG. 15 is a front view of the recording material removing device and FIG. 16 is a top view of the recording material removing device.

In FIGS. 15 and 16, a recording material removing device 301 principally includes: a recording material removing part 302 (see the center in FIGS. 15 and 16); a first recording medium feeding part 305 and a second recording medium feeding part 306 (see the right and left in the recording material removing part 302 at the center in FIGS. 15 and 16) which are joined through the recording material removing part 302 and a third and fourth guide plates 303 and 304 for guiding the feeding of the recording medium 74; an feeding/ejecting part 309 (see the left center in FIGS. 15 and 16) for the recording medium 74, joined with the first feeding part 305 through a second guide plate 307 for guiding the feeding of the recording medium 74, the feeding/ejecting part 309 including a first paper sensor 308; a first guide plate 310 for guiding the feeding of the recording medium 74 toward the left of the feeding/ejecting part 309 and an output tray 311 for storing the recording medium 74; and a fifth guide plate 312 following the right of the second recording medium feeding part 306 and for guiding the feeding of the recording medium 74. These components are attached to a frame 73. Further, a second paper sensor 313 is attached to the second guide plate 307. A second paper sensor 314 is attached to the third guide plate 303. A fourth paper sensor 315 is attached to the fourth guide plate 304. A fifth paper sensor 316 is attached to the fifth guide plate 312.

The structure (not shown) of the recording medium 74 used herein is identical to the recording medium 74 used in the first embodiment. It is explained in the first embodiment and the explanation thereof is omitted.

The structure of the recording material removing part 302 for the recording medium 74 will be explained first. Attached on a holder 317 is a squeezing member 318 with an arc-shaped end 370 pointing downward. Left and right control rollers 320 and 321 are rotatably mounted on a frame 373 so that the squeezing member 318 is interposed between the rollers during operation. Further, left and aright blades 322 and 323 are attached to blade holding members 319 and thus mounted on the frame 373 so that the squeezing member 318 is interposed between the blades.

The holder 317 is provided with an extended portion 324 extending from the holder 317. A first spur gear 325 provided in the extended portion 324 is connected to a first drive motor 327 through a first drive gear 326. The first drive motor 327 is fixed to a first motor supporting frame 328 which is fixed to the frame 373. Hence, the holder 317 can be moved up and down together with the squeezing member 318 according to the rotating direction of the first drive motor 327.

The structure of the first recording medium feeding part 305 will be described below. A first drive roller 329 made of a rubber material such as silicone and EPDM is formed in a cylindrical shape which covers a first drive roller shaft 330 made of metal. The first drive roller shaft 330 is rotatably attached to the frame 373. A second drive motor 331 is fixed to the frame 373 and has a shaft 375 on which a first pulley 332 is mounted. Mounted on the first drive roller shaft 330 of the first drive roller 329 is a second pulley 333. The first and second pulleys 332 and 333 are coupled through a first drive belt 334. Thus, driving force of the second drive motor 331 is transmitted to the first drive roller shaft 330 of the first drive roller 329 to rotate the first drive roller 329. According to the rotating direction of the second drive motor 331, the first drive roller 329 is rotated normally or reversely.

Above the first drive roller 329, a first pressure roller 335 made of a rubber material such as silicone and EPDM and formed in a cylindrical shape is placed. The first pressure roller 335 is centrally provided with a first pressure roller shaft 336 made of metal to rotate the first pressure roller 335. The first pressure roller shaft 336 is rotatably engaged in a first shaft supporting hole 338 of a first pressure roller supporting frame 337. The first pressure roller supporting frame 337 is provided with an extended portion 339 extending from the first pressure roller supporting frame 337. A second spur gear 340 provided in the extended portion 339 is connected to a third drive motor 342 through a second drive gear 341. The third drive motor 342 is fixed to a third motor supporting frame 343 which is fixed to the frame 373. Hence, the first pressure roller supporting frame 337 can be moved up and down together with the first pressure roller 335 according to the rotating direction of the third drive motor 342.

The structure of the second recording medium feeding part 306 will be described below. A second drive roller 344 made of a rubber material such as silicone and EPDM is formed in a cylindrical shape which covers a second drive roller shaft 345 made of metal. The second drive roller shaft 345 is rotatably attached to the frame 373. A fourth drive motor 346 is also fixed to the frame 373 and has a shaft 376 on which a third pulley 347 is mounted. Mounted on the second drive roller shaft 345 of the second drive roller 344 is a fourth pulley 348. The third and fourth pulleys 347 and 348 are coupled through a second drive belt 349. Thus, driving force of the fourth drive motor 346 is transmitted to the second drive roller shaft 345 of the second drive roller 344 to rotate the second drive roller 344. According to the rotating direction of the fourth drive motor 346, the second drive roller 344 is rotated normally or reversely.

Above the second drive roller 344, a second pressure roller 350 made of a rubber material such as silicone and EPDM and formed in a cylindrical shape is placed. The second pressure roller 350 is centrally provided with a second pressure roller shaft 351 made of metal to rotate the second pressure roller 350. The second pressure roller shaft 351 is rotatably engaged in a second shaft supporting hole 353 of a second pressure roller supporting frame 352. The second pressure roller supporting frame 352 is provided with an extended portion 354 extending from the second pressure roller supporting frame 352. A third spur gear 355 provided in the extended portion 354 is connected to a fifth drive motor through a third drive gear 356. The fifth drive motor 357 is fixed to a fifth motor supporting frame 358 which is fixed to the frame 373. Hence, the second pressure roller supporting frame 352 can be moved up and down together with the second pressure roller 350 according to the rotating direction of the fifth drive motor 357.

The structure of the feeding/ejecting part 309 for the recording medium 74 will be explained below. A feeding/ejecting plate 359 for feeding and ejecting the recording medium 74 is rotatably attached to the frame 373 through a fourth rotating shaft 360. Provided on an end face of the feeding/ejecting plate 359 is a slide shaft 361 which is engaged in a slide groove 363 formed in an end of a feeding/ejecting guide frame 362.

Provided in the other end of the feeding/ejecting guide frame 362 is an extended portion 365 formed with a fourth spur gear 364. The fourth spur gear 364 is connected to a sixth drive motor 367 through a fourth drive gear 366. The sixth drive motor 367 is fixed to the frame 373. Hence, the feeding/ejecting guide frame 362 can be moved up and down according to the rotating direction of the sixth drive motor 367. Such movements enable rotation of the feeding/ejecting plate 359 about the fourth rotating shaft 360, thereby moving the end of the plate 359 toward the first guide plate 310 or the output tray 311.

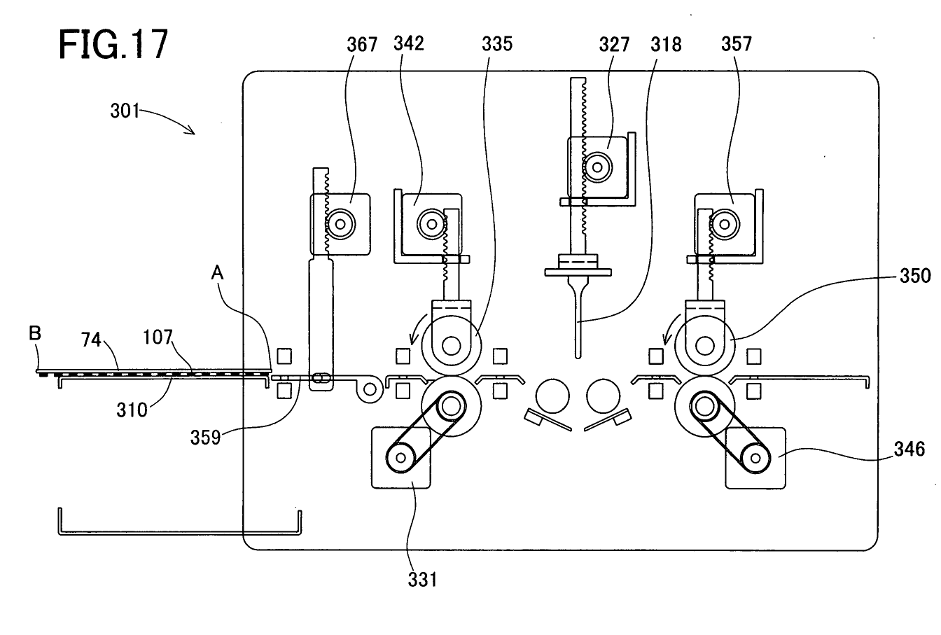

Next, the recording material removing device 301 constructed as above will be explained focusing on movements of the recording medium 74, referring to FIGS. 17 to 27. The recording medium 74, which is not fixed to any structure, is moved itself in response to respective operations of the first and second recording medium feeding parts 305 and 306.

FIGS. 17 to 27 are explanatory views showing steps in which the recording material removing device removes the recording material of the recording medium. Herein, the surface of the recording medium 74 having the separation layer on which the recording material 107 has been thermally fixed corresponds to a lower side of the recording medium 74 in the figures.

FIG. 17 is an explanatory view showing a step (1) in which the recording material removing device removes the recording material of the recording medium. FIG. 17 shows a state of the recording material removing device 301 in which the feeding/ejecting plate 359 is in an upper position by the sixth drive motor 367 and the first pressure roller 335 is in a lower position by the third drive motor 342, i.e., in a position for feeding the recording medium 74, the squeezing member 318 is in an upper position by the first drive motor 327, i.e., in a position for allowing the recording medium 74 to pass, and the second pressure roller 350 is in a lower position by the fifth drive motor 357, i.e., in a position for feeding the recording medium 74. The first and second pressure rollers 335 and 350 are rotated by the second and fourth drive motors 331 and 346 so as to convey the recording medium 74. The recording medium 74 with the recording material 107 side turning down is on standby on the first guide plate 310.

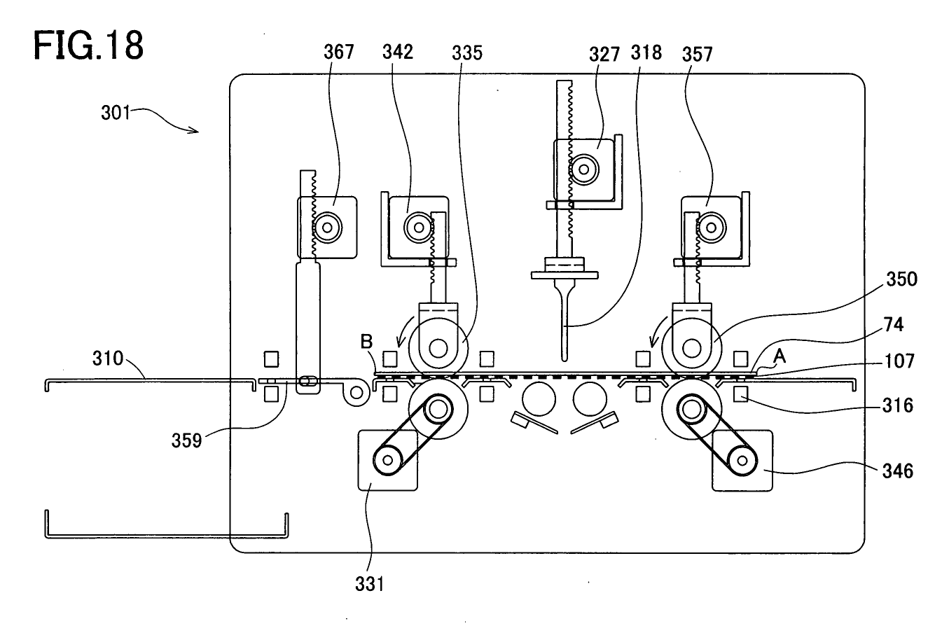

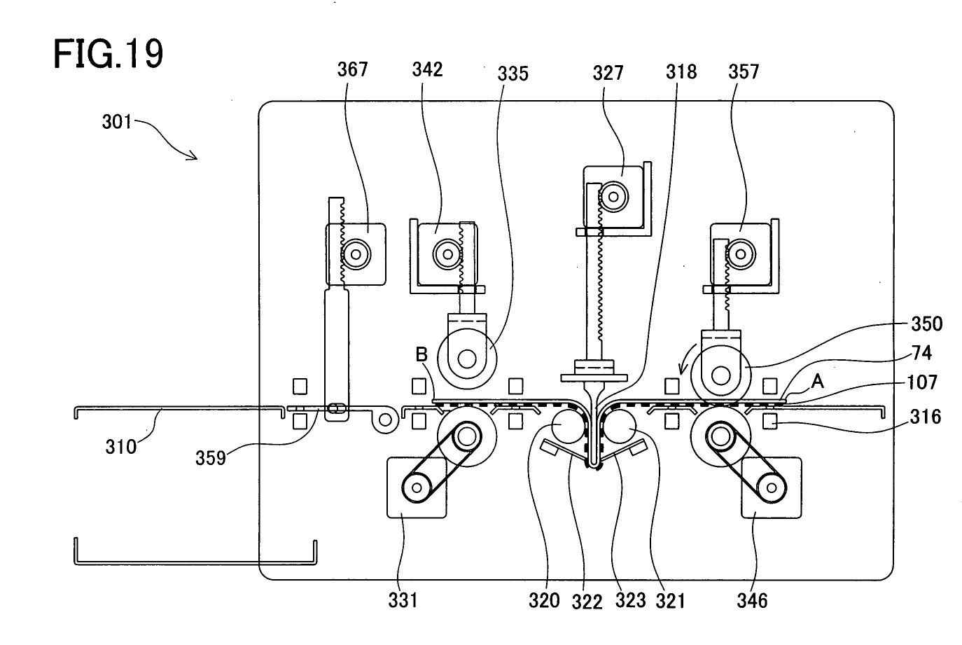

FIG. 18 an explanatory view showing a step (2) in which the recording material removing device removes the recording material of the recording medium. FIG. 18 shows a state of the recording material removing device 301 in which the feeding/ejecting plate 359 is in the upper position, the first pressure roller 335 is in the lower position, the squeezing member 318 is in the upper position, and the second pressure roller 350 is in the lower position. This is a state where the recording medium 74 is conveyed (rightwards in the figure) by driving of the second drive motor 331 and the fourth drive motor 346, and the fifth paper sensor 316 just detects a front edge A of the recording medium 74. When the fifth paper sensor 316 detects the front edge A of the recording medium 74, the state goes into a state shown in FIG. 19.

FIG. 19 is an explanatory view showing a step (3) in which the recording material removing device removes the recording material of the recording medium. FIG. 19 shows a state the recording material removing device 301 in which the feeding/ejecting plate 359 is in the upper position, the first pressure roller 335 is in an upper position by the third drive motor 342, i.e., in a position unrelated to feeding of the recording medium 74, the squeezing member 318 is in a lower position by the first drive motor 327, i.e., in a position where the squeezing member 318 squeezes the recording medium 74 controlled to move along the arc-shaped end 370 of the squeezing member 318 by the first left and right control rollers 320 and 321, thereby removing the recording material 107 by the right blade 323, and the second pressure roller 350 is in the lower position. This is a state where the second drive motor 331 is stopped and the fourth drive motor 346 is driven to move the recording medium 74 rightwards in the figure, starting to remove the recording material 107 by the right blade 323.

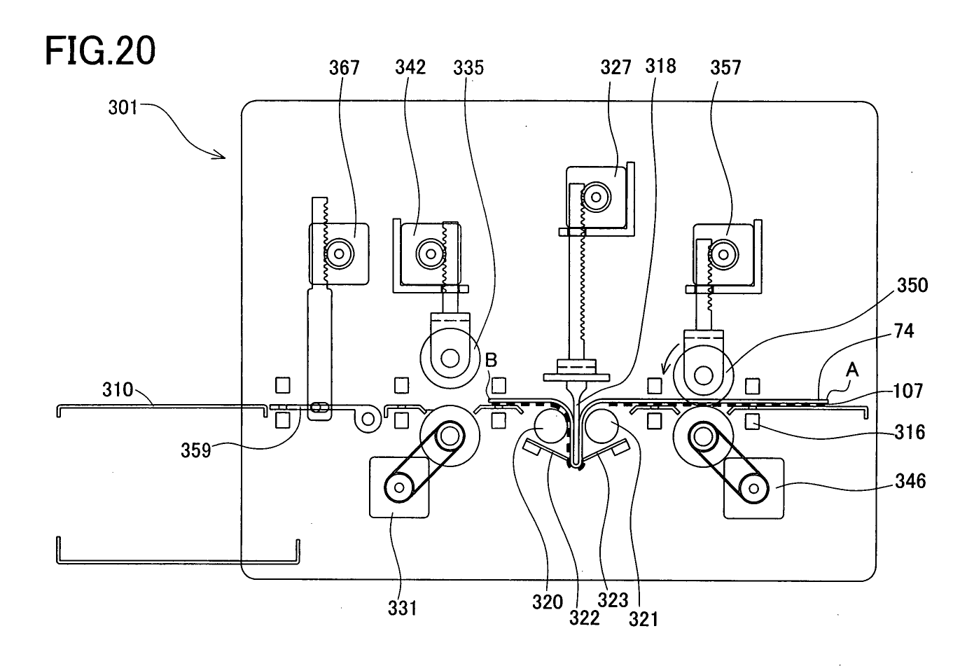

FIG. 20 is an explanatory view showing a step (4) in which the recording material removing device removes the recording material of the recording medium. FIG. 20 shows an advanced state of removal of the recording material 107 from the state of FIG. 19. In this state, the recording material 107 remains on the recording medium 74 from the front edge A thereof to the right blade 323.

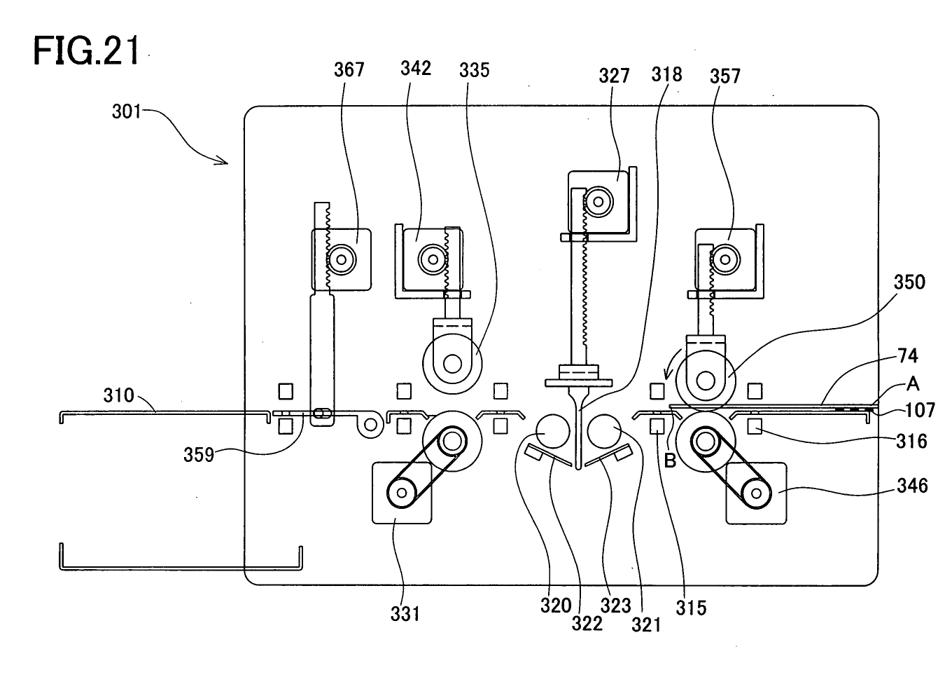

FIG. 21 is an explanatory view showing a step (5) in which the recording material removing device removes the recording material of the recording medium. FIG. 21 shows a state of the recording material removing device 301 in which the feeding/ejecting plate 359 is in the upper position, the first pressure roller 335 is in the upper position, the squeezing member 318 is in the lower position, and the second pressure roller 350 is in the lower position. This is a state where the recording medium 74 is conveyed (rightwards in the figure) by driving of the fourth drive motor 346 while the recording material 107 having adhesive force reduced by squeezing of the recording medium 74 by the squeezing member 318 is removed by the right blade 323, and a back edge B of the recording medium 74 is just detected by the fourth paper sensor 315.

Just after that, the fourth drive motor 346 is stopped driving, establishing a state where the feeding/ejecting plate 359 in the upper position, the first pressure roller 335 is in the lower position by the third drive motor 342, the squeezing member 318 is in the upper position by the first drive motor 327, and the second pressure roller 350 is in the lower position, and further a state where the second drive motor 331 and the fourth drive motor 346 are driven to convey the recording medium 74 (leftwards in the figure).

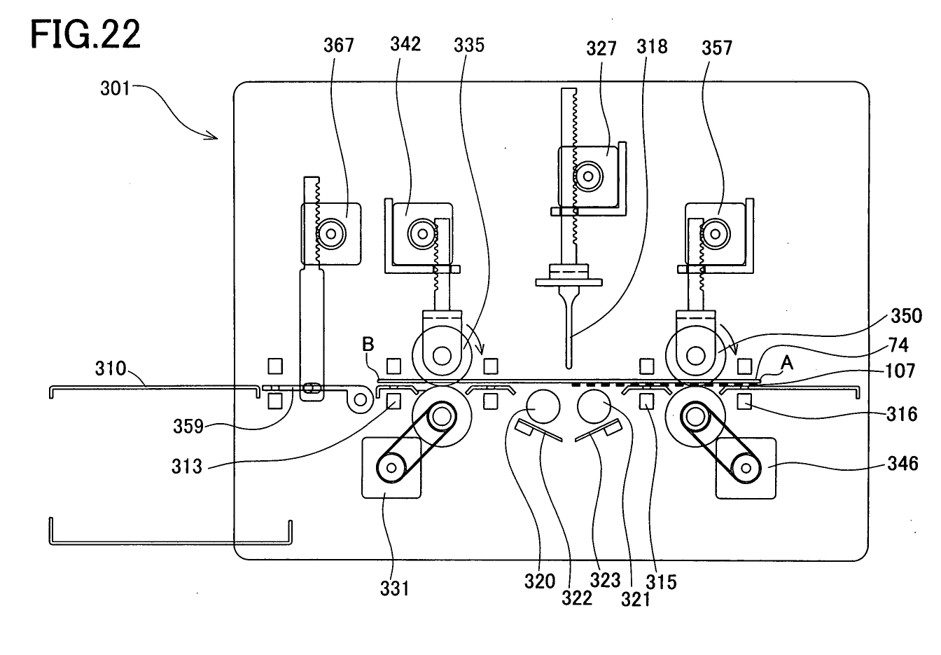

FIG. 22 is an explanatory view showing a step (6) in which the recording material removing device removes the recording material of the recording medium. FIG. 22 shows a state of the recording material removing device 301 in which the feeding/ejecting plate 359 is in the upper position, the first pressure roller 335 in the lower position, the squeezing member 318 in the upper position, and the second pressure roller 350 is in the lower position. This is a state just after the second paper sensor 313 detects the back edge B of the recording medium 74 conveyed (leftwards in the figure) by driving of the second drive motor 331 and the fourth drive motor 346.

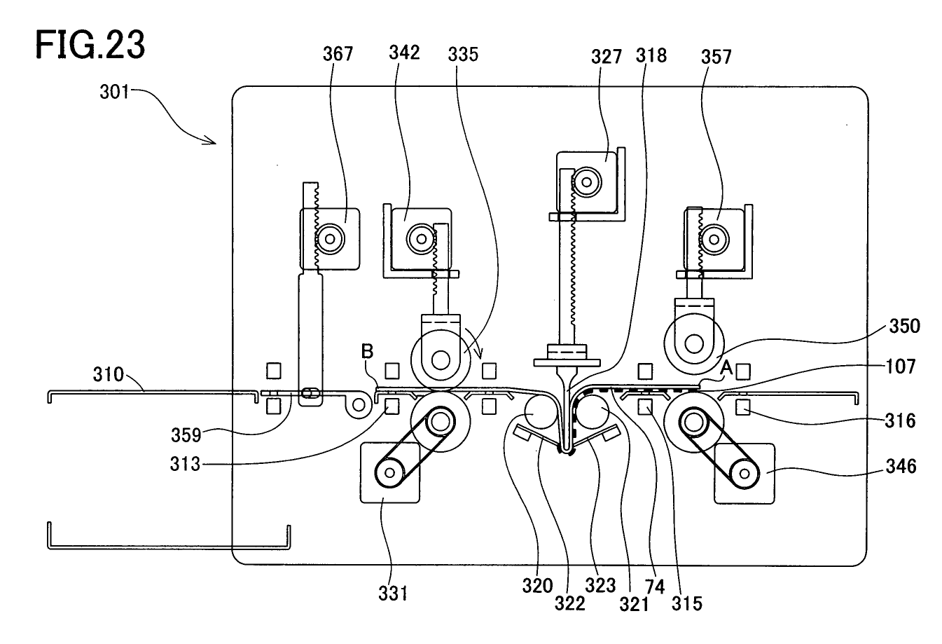

FIG. 23 is an explanatory view showing a step (7) in which the recording material removing device removes the recording material of the recording medium. FIG. 23 shows a state of the recording material removing device 301 in which the feeding/ejecting plate 359 is in the upper position, the first pressure roller 335 is in the lower position, the squeezing member 318 is in the lower position by the first drive motor 327, i.e., in a position where the left and right control rollers 320 and 321 controls the recording medium 74 to move along the arc-shaped end 370 of the squeezing member 318, thereby squeezing the recording medium 74, and the recording material 107 is removed by the left blade 322, and the second pressure roller 350 is in an upper position, i.e., in a position unrelated to the feeding of the recording medium 74. This is a state where the fourth drive motor 346 is stopped and the second drive motor 331 is driven to move the recording medium 74 leftwards in the figure, starting to remove the recording material 107 by the left blade 322.

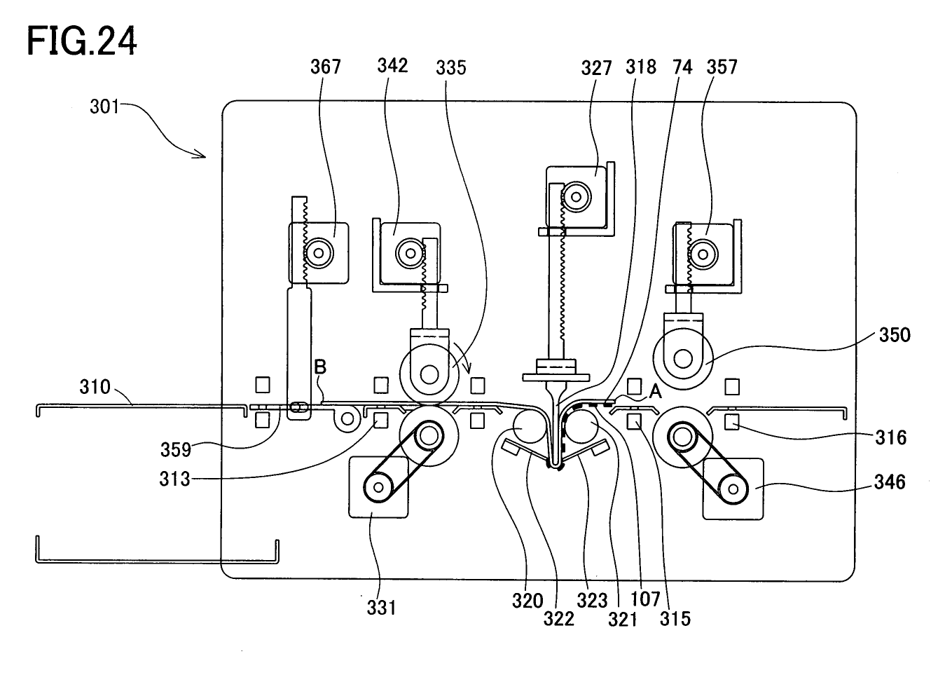

FIG. 24 is an explanatory view showing a step (8) in which the recording material removing device removes the recording material of the recording medium. FIG. 24 shows a further advanced state of removal of the recording material 107 from the state of FIG. 23.

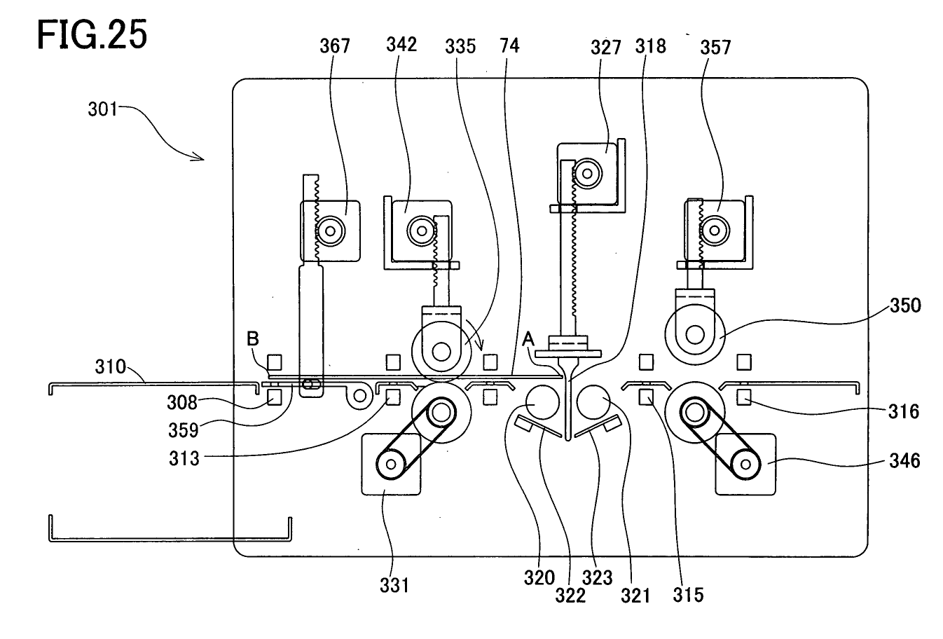

FIG. 25 is an explanatory view showing a step (9) in which the recording material removing device removes the recording material of the recording medium. FIG. 25 shows a state of the recording material removing device 301 in which the feeding/ejecting plate 359 is in the upper position, the first pressure roller 335 is in the lower position, the squeezing member 318 is in the lower position, and the second pressure roller 350 is in the upper position. This is a state where the second drive motor 331 is driven to convey the recording medium 74 leftwards in the figure while the recording material 107 is removed by the left blade 322, and the first paper sensor 308 just detects the back edge B of the recording medium 74.

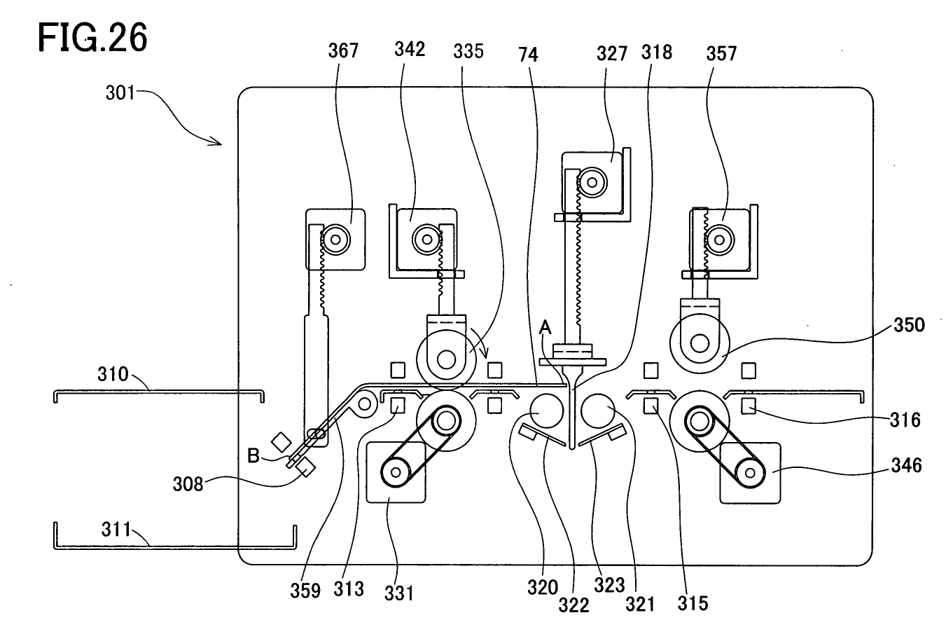

FIG. 26 is an explanatory view showing a step (10) in which the recording material removing device removes the recording material of the recording medium. FIG. 26 shows a state of the recording material removing device 301 in which the feeding/ejecting plate 359 is in a lower position by the sixth drive motor 367, the first pressure roller 335 is in the lower position, the squeezing member is in the lower position, and the second pressure roller 350 is in the upper position. When the first paper sensor 308 detects the back edge B of the recording medium 74, the sixth drive motor 367 is driven to bring the feeding/ejecting plate 359 to the lower position, thus conveying the recording medium 74 onto the output tray 11.

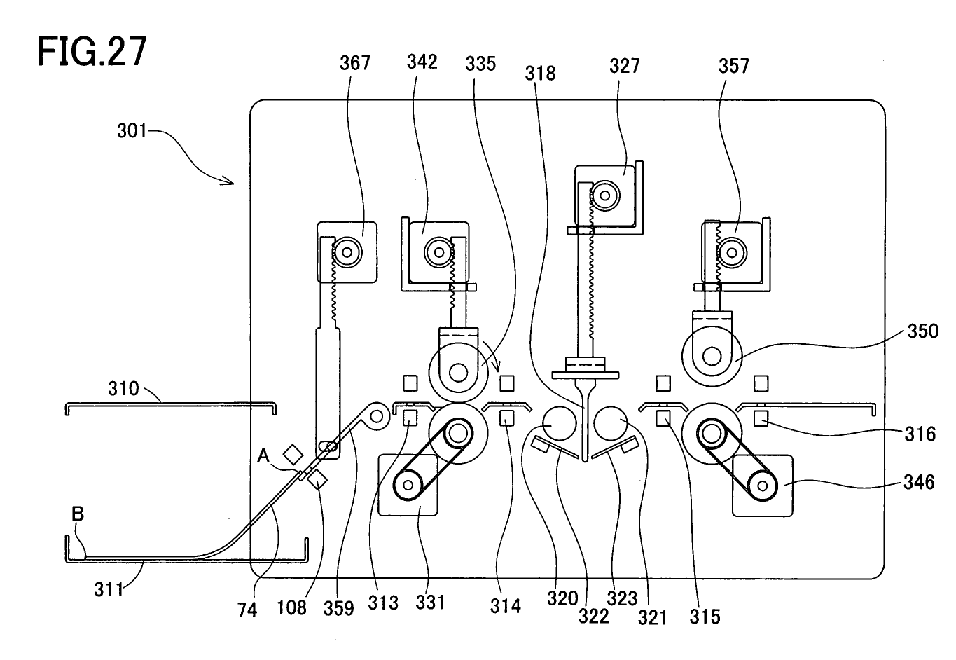

FIG. 27 is an explanatory view showing a step (11) in which the recording material removing device removes the recording material of the recording medium. FIG. 27 shows a state of the recording material removing device 301 in which the feeding/ejecting plate 359 is in the lower position, the first pressure roller 335 is in the lower position, the squeezing member 318 in the lower position, and the second pressure roller 350 in the upper position, i.e., a state near termination of the feeding from the state of FIG. 26. After that, the first pressure roller 335 is stopped rotating and the feeding/ejecting plate 359 is lifted up to the upper position by the sixth drive motor 367, i.e., toward the first guide plate 310. A series of the motions is thus terminated. By the above steps, the recording material 107 thermally fixed to the separation layer of the recording medium 74 can be removed completely from the recording medium 74.

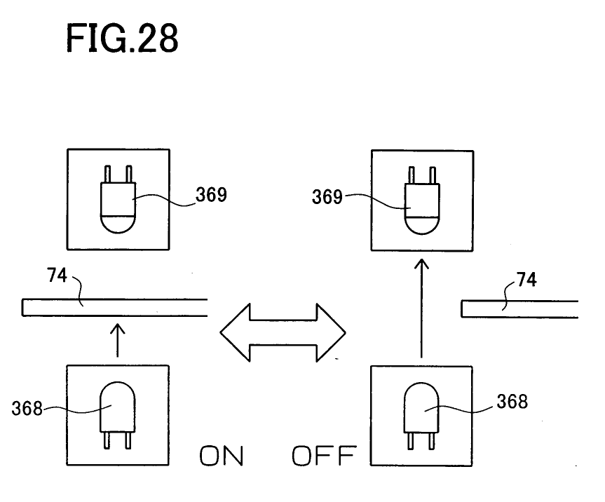

Next, each structure of the first to fifth paper sensors 308, 313, 314, 315, and 316 will be explained with reference to FIG. 28. FIG. 28 is a schematic view of an optical sensor constituted of LEDs used in the present invention. A light emitting device 368 and a photoreceptor device 369 are paired up. The light emitting device 368 and the photoreceptor device 369 are designed to be turned ON when the recording medium 74 exists therebetween, that is, when light is interrupted, and to be turned OFF when the recording medium 74 does not exist therebetween, that is, light is transmitted. Under this condition, the control of the drive motor is conducted sequentially according to a program, but its explanation is omitted herein.

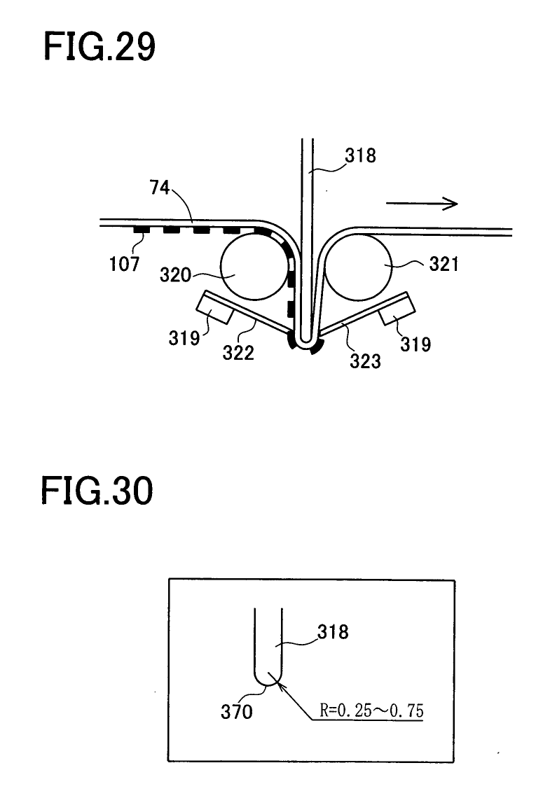

The explanation will be made on a process of removing the recording material 107 from the recording medium 74 by the squeezing member 318, referring to FIG. 29. FIG. 29 is an explanatory view showing the squeezing member and the blades that remove the recording material from the recording medium. The recording medium 74 is drawn under control of the left and right control rollers 320 and 321 so that the surface of the recording medium 74 having no separation layer comes in contact with the arc-shaped end of the squeezing member 318. When the left and right control rollers 320 and 321 control the recording medium 74 so that it is drawn along the arc-shaped end 370 of the squeezing member 318, the adhesive force between the recording material 107 and the separation layer is reduced. In this state, when the right blade 323 placed before the right control roller 321 is placed in contact with the recording medium 74 so as to wipe the recording material 107 having the reduced adhesive force, the recording material 107 can easily be removed from the recording medium 74. Since the recording material 107 is removed from the recording medium 74 by the right blade 323 while the recording medium 74 is drawn rightwards in the figure, the recording material 107 can be removed from the recording medium 74 without remaining on the back edge B thereof. When the recording material 107 is removed from the recording medium 74 by the left blade 322 while the recording medium 74 is drawn leftwards in the figure, the recording material 107 can be removed from the recording material 107 without remaining on the front edge thereof.

Moreover, the arc-shaped end 370 of the squeezing member 318 used in the present invention will be explained with reference to FIG. 30. FIG. 30 is an enlarged view showing the arc-shaped end of the squeezing member. The radius of the arc-shaped end 370 is preset in a range of 0.25 recording material to 0.75 recording material. If the radius of the arc-shaped end is smaller than the range, the arc-shaped end will take a larger load when the recording medium 74 is drawn and the recording medium 74 is likely to get damaged or scratched. If the end of the squeezing member 318 is too round, it will cause a problem that unsatisfactory squeezing could not reduce the adhesive force between the recording material 107 and the separation layer and a problem that the recording material 107 remains unremoved.

As explained above, the recording material removing device 301 in the third embodiment includes the squeezing member 318 provided with the arc-shaped end at a distal end, the left and right control rollers 320 and 321 for controlling the recording medium 74 so as to bring the surface having no separation layer into contact with the arc-shaped end 370 of the squeezing member 318, and the left and right blades 322 and 323 for removing the recording material 107 thermally fixed on the separation layer of the recording medium 74, the blades 322 and 323 being provided in a control region of the recording medium 74 to be controlled by the left and right control rollers 320 and 321. Accordingly, the left and right control rollers 320 and 321 first control the recording medium 74 to bring the surface having no separation layer into contact with arc-shaped end 370, thereby reducing the adhesive force between the recording material 107 thermally fixed on the separation layer of the recording medium 74 and the separation layer. Then, the recording material 107 having thermally been fixed on the separation layer of the recording medium 74 and having the reduced adhesive force with respect to the separation layer is removed by the left and right blades 322 and 323. Consequently, there is no need to apply any additional force to the recording medium 74 by the left blade 322 or the right blade 323. It is further possible to easily remove the recording material 107 from the recording medium 74 without damaging or scratching the recording medium 74.

In the recording material removing device 301, furthermore, the recording medium 74 is not fixed for feeding and only the recording medium 74 is allowed to reciprocate, thereby removing the recording material 107 from the entire surface of the recording medium 74. Accordingly, it is possible to extremely easily remove the recording material 107 from the entire surface of the recording medium 74 including the fixed portion, the front edge A, and the back edge B of the recording medium 74 from which the recording material could not be removed so far.

In the recording material removing device 301, squeezing of the recording medium 74 and removal of the recording material 107 are performed by the squeezing member 318 of which the arc-shaped end 370 has a radius of 0.25 recording material to 0.75 recording material. It is therefore possible to provide the recording material removing device 301 capable of preventing damages or scratches to the recording medium 74 which would be caused by an excessively sharp end of the squeezing member 318 or preventing unsatisfactory squeezing and unremoved recording material 107 which would be caused by an excessively round end of the squeezing member 318.

In the recording material removing device 301 for the recording medium, squeezing of the recording medium 74 and removal of the recording material 107 are performed under control of the two left and right control rollers 320 and 321 which interpose the recording medium 74 therebetween so as to bring the recording medium 74 into contact with the arc-shaped end 370 of the squeezing member 318. Consequently, it is possible to reduce frictional resistance caused by drawing of the recording medium 74.

### Fourth Embodiment

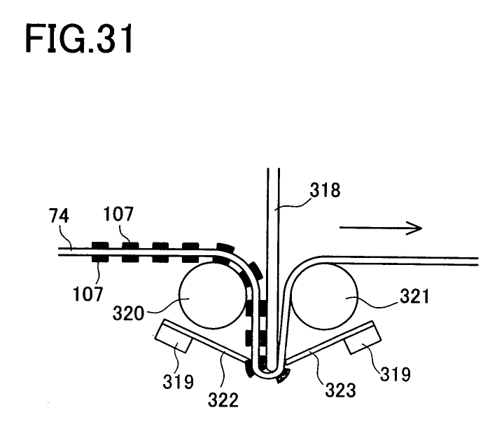

In a fourth embodiment, a method of removing the recording material 107 having thermally been fixed on the separation layers of both surfaces of the recording medium 74 will be explained with reference to FIG. 31. FIG. 31 is an explanatory view showing the method of removing the recording material thermally fixed on the separation layers of both surfaces of the recording medium. Removal of the recording material 107 is simultaneously performed from an upper and lower surfaces of the recording medium 74 which will be mentioned below, so that the recording material 107 thermally fixed on the separation layers of both surfaces of the recording medium 74 can be removed by one reciprocal motion of the recording medium 74. The recording medium 74, which is not fixed to any structure, is moved itself in response to respective operations of the first and second recording medium feeding parts 305 and 306.

The method of removing the recording material 107 thermally fixed on the separation layers on the upper surface of the recording medium 74 will be explained first. The recording medium 74 is drawn under control of the left and right control rollers 320 and 321 which bring the upper surface of the recording medium 74 into contact with the arc-shaped end 370 of the squeezing member 318. By squeezing under control of the left and right control rollers 320 and 321 which bring the recording medium 74 into contact with the arc-shaped end 370 of the squeezing member 318, the adhesive force between the recording material 107 and the separation layer is reduced. In this state, when the recording medium 74 is drawn so as to be squeezed by the squeezing member 318, the recording material 107 can easily be removed from the recording medium 74. Since the recording material 107 is removed from recording medium 74 by drawing the recording medium 74 rightwards in the figure, the recording material 107 can be removed without remaining on the back edge B of the recording medium 74. Further, when the recording material 107 is removed from the recording medium 74 by drawing the recording medium 74 leftwards in the figure, the recording material 107 can be removed without remaining on the front edge of the recording medium 74.

The method of removing the recording material 107 thermally fixed on the separation layer of the lower surface of the recording medium 74 will be explained below. The recording medium 74 is drawn under control of the left and right control rollers 320 and 321 which bring the upper surface of the recording medium 74 into contact with the arc-shaped end 370 of the squeezing member 318. By squeezing under control of the left and right control rollers 320 and 321 which bring the recording medium 74 into contact with the arc-shaped end 370 of the squeezing member 318, the adhesive force between the recording material 107 and the separation layer is reduced. In this state, when the right blade 323 placed before the right control roller 321 comes in contact with the recording medium 74 so as to wipe the recording material 107, the recording material 107 can easily be removed from the recording medium 74. Since the recording material 107 is removed from the recording medium 74 by the right blade 323 while the recording medium 74 is drawn rightwards in the figure, the recording material 107 can be removed from the recording medium 74 without remaining on the back edge B thereof. Further, when the recording material 107 is removed from the recording medium 74 by the left blade 322 while the recording medium 74 is drawn leftwards in the figure, the recording material 107 can be removed from the recording material 107 without remaining on the front edge thereof.

As explained above, in the recording material removing device 301 for the recording medium, the recording medium 74 having the separation layers on both surfaces on which the recording material 107 has thermally been fixed is not fixed for feeding and is allowed to reciprocate, thereby removing the recording material 107 from both surfaces of the recording medium 74 at the same time. Accordingly, the recording material 107 can be removed from both surfaces of the recording medium 74 by one reciprocal motion. Furthermore, it is possible to extremely easily remove the recording material 107 from both entire surfaces of the recording medium 74 including the fixed portion, the front edge A, the back edge B of the recording medium 74 from which the recording material could not be removed so far.

The present invention is not limited to the first to fourth embodiments and may be embodied in other specific forms without departing from the spirit or essential characteristics thereof For instance, in the above first and second embodiments, metal such as 301 stainless steel is used for the first separating member 2 and the second separating member 202, but polyimide resin and polycarbonate resin may be used.

Further, in the above second embodiment, two heaters, the heater 20 and the heater 220, are used, but only either one may be used.

In the above second embodiment, individual drive motors are used for explanation of operations, but some of them may be shared. For example, the first drive motor 15 and the fourth drive motor 215, the third drive motor 61 and the sixth drive motor 261, and others are shared.

In the above first and second embodiments, furthermore, metal is used for the first blade 47 and the second blade 247, but resin such as polycarbonate resin or the like may be used.

In the above first embodiment, the first rotating projection 56 is periodically brought into contact with the first projection 58 to reciprocate the first blade 47. Alternatively, a link mechanism (crank mechanism) may be used. This can also be applied to the first blade 47 and the second blade 247 in the second embodiment.

In the above first embodiment, the drive motors are used individually, but some of them may be shared. For example, the second drive motor 55 and the third drive motor 61 may be shared. This can also be applied to the fifth drive motor 255 and the sixth drive motor 261 in the second embodiment.

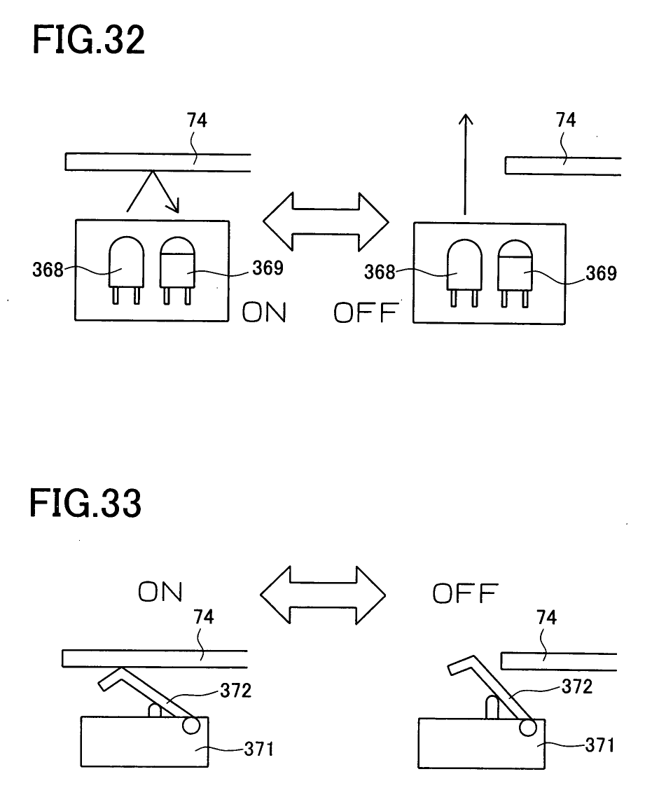

In the third and fourth embodiments, the optical sensor of a transmitting type is used as the paper sensor, but it is not limited thereto. For example, an optical sensor of a reflecting type in which the light emitting devices 368 and the photoreceptor devices 369 are arranged in parallel as shown in FIG. 32 to detect the light reflected from the recording medium 74 may be used. FIG. 32 is an explanatory view showing the example of the paper sensor using light. Alternatively, a mechanical switch sensor shown in FIG. 33 in which the recording medium 74 pushes a pressing piece 372 of a mechanical switch 371 to thereby turn the switch ON/OFF may be used. FIG. 33 is an explanatory view of the example of the paper sensor using the mechanical switch.

Moreover, in the above third and fourth embodiments, some of the drive motors may be shared. For example, the second drive motor 331 and the fourth drive motor 346 may be shared when the function of one of them is made unused.

In the above third and fourth embodiments, in the first recording medium feeding part 305 of FIG. 15, the rotation of the second drive motor 331 is transmitted to the first drive roller 329 through the first pulley 332, the second pulley 333, and the first drive belt 334. The rotation however may be transmitted through gears. Similarly, in the second recording medium feeding part 306 of FIG. 15, the rotation of the fourth drive motor 346 is transmitted to the second drive roller 344 through the third pulley 347, the fourth pulley 348, and the second drive belt 349. The rotation however may be transmitted through gears.

In the above third and fourth embodiments, further, the left blade 322 and the right blade 323 shown in FIG. 29 may be configured to have elasticity so that the left blade 322 and the right blade 323 come in closer contact with the recording medium 74.

In the above third and fourth embodiments, the squeezing member 318 shown in FIG. 29 may be formed in inverted triangular shape and with an arc-shaped end having a radius of 0.25 to 0.75 mm recording material at the apex of the triangle. Further, a pressure sensor may be attached to the left blade 322 and the right blade 323 to control the first drive motor 327 according to a detection signal representative of the pressure which the blades receive from the recording medium 74 so that the pressure becomes optimum for removing the recording material 107.

In the above third and fourth embodiments, in the state shown in FIG. 25, the first paper sensor 308 stops the detection of the back edge B of the recording medium 74 whereas the third paper sensor 314 detects the front edge B of the recording medium 74, and returning to the step of FIG. 18, the step of FIG. 18 and subsequent steps are repeated, thereby causing the recording medium 74 to reciprocate by the desired number of times to remove the recording material 107.

What is claimed is:

1. A recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated and removed from the recording medium,
wherein the recording material removing device is constructed to bond the recording medium to the separating member by the recording material melted or softened when the recording medium is brought into contact with the heated belt-shaped separating member, and separate the recording medium from the separating member when the recording material is cooled and solidified while the separating member and the recording medium are nipped by the nipping member.

2. The recording material removing device according to claim 1, wherein the separating member and the recording medium are nipped by the nipping member until the recording medium is separated from the separating member, and the recording medium is separated from the separating member after the recording material becomes a glass-transition temperature (Tg) or less.

3. The recording material removing device according to claim 1, wherein the nipping member is a roller.

4. The recording material removing device according to claim 1, wherein the separating member and the recording medium, which have been bonded by the recording material melted or softened by heat, are drawn in a bonded state along a tangent line to a heating source.

5. A recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated and removed from the recording medium,
wherein the recording material removing device comprises a first separating member and a second separating member and is constructed to nip and convey the recording medium by the heated first separating member and the second separating member, and separate the recording medium from the first separating member and the second separating member when the recording material bonding the recording medium and the first separating member and the second separating member is cooled and solidified.

6. The recording material removing device according to claim 5, wherein the recording medium is nipped and conveyed by the first separating member and the second separating member, and the recording medium is separated from the first separating member and the second separating member after the recording material becomes a glass-transition temperature (Tg) or less.

7. The recording material removing device according to claim 5, wherein the first separating member and the second separating member are further nipped by rollers.

8. The recording material removing device according to claim 5, wherein the first separating member and the second separating member and the recording medium, which have been bonded by the recording material melted or softened by heat, are drawn in a bonded state along a tangent line of a heating source.

9. A recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated from the recording medium and removed,
wherein the recording material removing device comprises a recording material removing blade for removing the recording material by coming in contact with a surface of the separating member and a supporting member in a position opposite to the recording material removing blade with the separating member being interposed therebetween, and the recording material removing blade is configured to reciprocate with respect to the separating member while pressing against the supporting member through the separating member.

10. The recording material removing device according to claim 9, wherein the recording material removing blade is configured to reciprocate along a traveling direction of the separating member.

11. The recording material removing device according to claim 9, wherein the reciprocating motion of the recording material removing blade is faster than a moving speed of the separating member.

12. The recording material removing device according to claim 9, wherein the recording material removing blade is elasticized.

13. A recording material removing device in which a recording material having thermally been fixed on a recording medium is heated to be melted or softened, a belt-shaped separating member made of a material providing a surface thereof with a stronger adhesive force with respect to the recording material than an adhesive force between the recording medium and the recording material is brought into contact with the recording material, and then the separating member and the recording medium are separated, during which separation the recording material is separated from the recording medium and removed,
wherein the recording material removing device comprises a recording material removing blade for removing the recording material by coming in contact with a surface of the separating member, a supporting member in a position opposite to the recording material removing blade with the separating member being interposed therebetween, and a cleaning member for simultaneously cleaning the recording material removing blade and the separating member while the recording material removing blade removes the recording material from the separating member by pressing against the supporting member through the separating member.

14. The recording material removing device according to claim 13, wherein the cleaning member is a rotating brush.

15. A recording material removing device for removing a recording material on a recording medium by pressing a blade against a separation layer on the recording medium on which the recording material has thermally been fixed,
wherein the recording material removing device comprises a squeezing member provided with an arc-shaped end at a distal end, a control member for controlling so that a surface of the recording medium having no separation layer comes in contact with the arc-shaped end of the squeezing member, a blade for removing the recording material thermally fixed on the separation layer on the recording medium in a control region to be controlled by the control member.

16. The recording material removing device according to claim 15 comprising a recording medium feeding part whereby the recording medium is reciprocate, thereby removing the recording material from an entire surface of the recording medium.

17. The recording material removing device according to claim 15 comprising a recording medium feeding part whereby the recording medium having separation layers on both surfaces on which the recording material has thermally been fixed is reciprocate, thereby removing the recording material from both surfaces of the recording medium simultaneously.

18. The recording material removing device according to claim 15, wherein a radius of the arc-shaped end of the squeezing member is 0.25 to 0.75 recording material.

19. The recording material removing device according to claim 15, wherein the control member includes two rollers interposing the squeezing member therebetween.
